(19) United States
(12) Patent Application Publication
(10) Pub. No.: US 2025/0138259 A1
(43) Pub. Date: May 1, 2025

(54) Optical Module

(71) Applicant: HISENSE BROADBAND MULTIMEDIA TECHNOLOGIES CO., LTD., Qingdao (CN)

(72) Inventors: Sigeng YANG, Qingdao (CN); Hongwei ZHANG, Qingdao (CN); Honghao ZHANG, Qingdao (CN)

(73) Assignee: HISENSE BROADBAND MULTIMEDIA TECHNOLOGIES CO., LTD., Qingdao (CN)

(21) Appl. No.: 19/004,161

(22) Filed: Dec. 27, 2024

Related U.S. Application Data
(63) Continuation of application No. PCT/CN2023/130933, filed on Nov. 10, 2023.

(30) Foreign Application Priority Data
Jul. 26, 2023 (CN) 202310926993.4
Jul. 26, 2023 (CN) 202310927220.8
Jul. 26, 2023 (CN) 202310929464.X
Jul. 26, 2023 (CN) 202310929571.2
Jul. 26, 2023 (CN) 202321985981.0
Jul. 26, 2023 (CN) 202321990186.0

(51) Int. Cl. G02B 6/42

(52) U.S. Cl. CPC G02B 6/4214; G02B 6/428

(57) ABSTRACT

An optical module including an optical waveguide substrate, a turning prism, an optical reception chip, a laser chip, a reflector and a displacement prism. The optical waveguide substrate is provided, at different sides thereof, with input optical ports and output optical ports to transmit optical reception and emission signals. The laser chip is arranged in a layer different from that of the optical waveguide substrate, so as to guide an optical emission signal from the laser chip into one input optical port. The reflector is arranged in an output optical path of the laser chip to reflect the optical emission signal from the laser chip. A light input end of the displacement prism faces the layer where the laser chip is located, a light output end thereof faces one input optical port to guide the optical emission signal reflected by the reflector into the optical waveguide substrate.

### CROSS-REFERENCE TO RELATED APPLICATIONS

This application is a continuation application of PCT/CN2023/130933 filed on Nov. 10, 2023, which claims priorities to Chinese application No. 202321990186.0, filed on Jul. 26, 2023, with the China National Intellectual Property Administration (CNIPA); Chinese application No. 202310927220.8, filed on Jul. 26, 2023, with the CNIPA; Chinese application No. 202321985981.0, filed on Jul. 26, 2023, with the CNIPA; Chinese application No. 202310926993.4, filed on Jul. 26, 2023, with the CNIPA; Chinese application No. 202310929571.2, filed on Jul. 26, 2023, with the CNIPA; and Chinese application No. 202310929464.X, filed on Jul. 26, 2023, with the CNIPA, the entire disclosures of which are incorporated herein by reference.

### FIELD

This disclosure relates to the technical field of optical fiber communication technology, particularly to an optical module.

### BACKGROUND

Developments and progresses of optical communication technology have become increasingly important with developments of new services and application modes such as cloud computing, mobile internet, and video. In optical communication technology, the optical module is a tool that realizes mutual conversion of optical and electrical signals, is one of the key devices in optical communication equipment, and is at the core of optical communication.

### SUMMARY

This disclosure provides an optical module including a circuit board; an optical waveguide substrate, a turning prism, an optical reception chip, a laser chip, a reflector and a displacement prism. The optical waveguide substrate includes a first input optical port and a first output optical port arranged at opposite sides to transmit an optical reception signal, and a second input optical port and a second output optical port arranged at adjacent sides to transmit an optical emission signal, wherein the first input optical port and the second output optical port are at the same side, and the first output optical port and the second input optical port are at different sides. The turning prism is arranged at a side of the first output optical port and is configured to receive and reflect the optical reception signal. The optical reception chip is disposed on a surface of the circuit board and is configured to receive the optical reception signal reflected by the turning prism. The laser chip is electrically connected to the other surface of the circuit board, the laser chip and the optical waveguide substrate are located at different layers, and the laser chip is configured to generate an optical emission signal. The reflector is arranged in an output optical path of the laser chip and is configured to reflect the optical emission signal. A light input end of the displacement prism faces the reflector, a light output end of the displacement prism faces the second input optical port, and the displacement prism is configured to guide the optical emission signal output from the reflector to the second input optical port so as to transmit the optical emission signal through the optical waveguide substrate.

### BRIEF DESCRIPTION OF DRAWINGS

In order to illustrate technical solutions disclosed in this disclosure more clearly, a brief description on the accompanying drawings used in some embodiments of this disclosure will be given below. It is obvious that the accompanying drawings described below are only those of some embodiments of this disclosure, and for those skilled in the art, other accompanying drawings may also be obtained based on these drawings. In addition, the accompanying drawings described below may be regarded as schematic diagrams and are not intended to limit actual size of the relevant products, actual process of the relevant methods, actual timing of signals or the like involved in the disclosed embodiments.

FIG. 1 is a partial structural diagram of an optical communication system provided according to some embodiments of this disclosure;

FIG. 2 is a partial structural diagram of a host computer provided according to some embodiments of this disclosure;

FIG. 3 is a structural diagram of an optical module provided according to some embodiments of this disclosure;

FIG. 4 is an exploded diagram of an optical module provided according to some embodiments of this disclosure;

FIG. 5 is a schematic diagram showing an assembly of an interface claw member and an optical fiber plug according to some embodiments of the present disclosure;

FIG. 6 is a schematic structural diagram of an interface claw member provided according to some embodiments of the present disclosure;

FIG. 7 is a disassembled schematic view of an interface claw member and an optical fiber plug according to some embodiments of the present disclosure;

FIG. 8 is an assembly schematic diagram of a cover shell and a base according to some embodiments of the present disclosure;

FIG. 9 is a schematic sectional view of an interface claw member according to some embodiments of the present disclosure;

FIG. 10 is a first partial exploded schematic diagram of an optical module provided according to some embodiments of the present disclosure;

FIG. 11 is a second partial exploded schematic diagram of an optical module provided according to some embodiments of the present disclosure;

FIG. 12 is a first structural diagram of a cover shell provided according to some embodiments of the present disclosure;

FIG. 13 is a second structural diagram of a cover shell provided according to some embodiments of the present disclosure;

FIG. 14 is a first structural diagram of a base provided according to some embodiments of the present disclosure;

FIG. 15 is a second structural diagram of a base provided according to some embodiments of the present disclosure;

FIG. 16 is a third structural diagram of a base provided according to some embodiments of the present disclosure;

FIG. 17 is a first sectional diagram of an assembly of a cover shell and a base according to some embodiments of the present disclosure;

FIG. 18 is a first disassembled schematic diagram of a cover shell and a base according to some embodiments of the present disclosure;

FIG. 19 is a second sectional schematic diagram of an assembly of a cover shell and a base according to some embodiments of the present disclosure;

FIG. 20 is a second disassembled schematic diagram of a cover shell and a base according to some embodiments of the present disclosure;

FIG. 21 is a schematic structural diagram of an optical waveguide substrate provided according to some embodiments of the present disclosure;

FIG. 22 is a schematic diagram illustrating an optical path for transmitting an optical signal through an optical waveguide substrate according to some embodiments of the present disclosure;

FIG. 23 is a sectional view of an internal structure of an optical module provided according to some embodiments of the present disclosure;

FIG. 24 is a schematic structural diagram of a protective cover provided according to some embodiments of the present disclosure;

FIG. 25 is a first schematic sectional view of a protective cover according to some embodiments of the present disclosure in an assembly state;

FIG. 26 is a second schematic sectional view of a protective cover according to some embodiments of the present disclosure in an assembly state;

FIG. 27 is a schematic view of a protective cover according to some embodiments of the present disclosure in a disassembled state;

FIG. 28 is a schematic diagram of a transmission optical path of an optical reception component according to some embodiments of the present disclosure;

FIG. 29 is a first schematic diagram illustrating relative position relationship of a circuit board, an optical emission component and an optical reception component according to some embodiments of the present disclosure;

FIG. 30 is a second schematic diagram illustrating the relative position relationship among a circuit board, an optical emission component and an optical reception component according to some embodiments of the present disclosure;

FIG. 31 is a structural diagram of an optical reception chip provided according to some embodiments of the present disclosure;

FIG. 32 is an exploded schematic diagram of an optical reception chip provided according to some embodiments of the present disclosure;

FIG. 33 is an exploded schematic diagram of another optical reception chip provided according to some embodiments of the present disclosure;

FIG. 34 is a sectional view of an internal structure of another optical module provided according to some embodiments of the present disclosure;

FIG. 35 is a sectional view of an internal structure of another optical module provided according to some embodiments of the present disclosure;

FIG. 36 is a structural diagram of an optical emission component provided according to some embodiments of the present disclosure;

FIG. 37 is a sectional view of an optical emission component provided according to some embodiments of the present disclosure;

FIG. 38 is a partial structural diagram of an optical emission component provided according to some embodiments of the present disclosure;

FIG. 39 shows an optical path of an optical emission component provided according to some embodiments of the present disclosure;

FIG. 40 is a first side sectional view of an optical emission component according to some embodiments of the present disclosure; and

FIG. 41 is a second side sectional view of an optical emission component provided according to some embodiments of the present disclosure.

### DETAILED DESCRIPTION

In the optical communication technology, it is generally necessary to load information onto light and use the propagation of light to achieve information transmission, so as establish information transmission between information processing devices. In this regard, the light loaded with information is namely an optical signal. The optical signal is propagated in the information transmission devices, which may reduce loss of optical power and achieve high-speed, long-distance, and low-cost information transmission. The information that may be processed by the information processing device is an electrical signal. The information processing device generally includes an optical network unit (ONU), a gateway, a router, a switch, a mobile phone, a computer, a server, a tablet, a television and the like, and the information transmission device typically includes an optical fiber, a waveguide and the like.

Mutual conversion of optical and electrical signals between the information processing device and the information transmission device may be achieved through optical modules. For example, an optical fiber may be connected to an optical signal input and/or output terminal of an optical module, and an optical network unit may be connected to an electrical signal input and/or output terminal of the optical module; a first optical signal from the optical fiber is transmitted to the optical module, which converts the first optical signal into a first electrical signal, and then transmits the first electrical signal to the optical network unit; a second electrical signal from the optical network unit is transmitted into the optical module, which converts the second electrical signal into a second optical signal, and then transmits the second optical signal to the optical fiber. Since information transmission between multiple information processing devices may be made via an electrical signal, at least one of the information processing devices needs to be directly connected to the optical module, and it is unnecessary for all of the information processing devices to be directly connected to the optical module. The information processing device directly connected to the optical module is called as a host computer of the optical module. In addition, the optical signal input end or the optical signal output end of the optical module may be called as an optical port, and the electrical signal input end or the electrical signal output end of the optical module may be called as an electrical port.

FIG. 1 is a partial structural diagram of an optical communication system provided according to some embodiments of the present disclosure. As shown in FIG. 1, the optical communication system mainly includes a remote information processing device 1000, a local information processing device 2000, a host computer 100, an optical module 200, an optical fiber 101, and a network cable 103.

One end of the optical fiber 101 extends towards the remote information processing device 1000, while the other end thereof is coupled to the optical module 200 through the optical port of the optical module 200. An optical signal may undergo a total reflection in the optical fiber 101, and propagation of the optical signal in a total reflection direction can almost maintain the original optical power. The optical signal undergoes multiple total reflections in the optical fiber 101, such that the optical signal from the remote information processing device 1000 is transmitted into the optical module 200, or the optical signal from the optical module 200 is transmitted to the remote information processing device 1000, thereby achieving long-distance information transmission with low power loss.

The optical communication system may include one or more optical fiber 101. The optical fiber 101 may be detachably connected or fixedly connected to the optical module 200. The host computer 100 is configured to provide data signals to the optical module 200, receive data signals from the optical module 200, or monitor or control the working state of the optical module 200.

The host computer 100 includes a substantially rectangular housing and an optical module interface 102 disposed on the housing. The optical module interface 102 is configured to connect to the optical module 200 such that a unidirectional or bidirectional electrical signal connection is established between the host computer 100 and the optical module 200.

The host computer 100 includes an external electrical interface which may be coupled to the electrical signal network. For example, the external electrical interface includes a Universal Serial Bus (USB) interface or a network cable interface 104, and the network cable interface 104 is configured to be coupled by the network cable 103, thereby establishing a unidirectional/bidirectional electrical signal connection between the host computer 100 and the network cable 103. One end of the network cable 103 is connected to the local information processing device 2000, and the other end thereof is connected to the host computer 100, so as to establish an electrical signal connection between the local information processing device 2000 and the host computer 100 through the network cable 103. For example, a third electrical signal emitted by the local information processing device 2000 is transmitted to the host computer 100 through the network cable 103; the host computer 100 generates a second electrical signal based on the third electrical signal; the second electrical signal from the host computer 100 is transmitted to the optical module 200; the optical module 200 converts the second electrical signal into a second optical signal, and transmits the second optical signal to the optical fiber 101, and the second optical signal is transmitted to the remote information processing device 1000 through the optical fiber 101. For example, a first optical signal from the remote information processing device 1000 is propagated through the optical fiber 101; the first optical signal from the optical fiber 101 is transmitted into the optical module 200; the optical module 200 converts the first optical signal into a first electrical signal, and transmits the first electrical signal to the host computer 100; the host computer generates a fourth electrical signal based on the first electrical signal, and transmits the fourth electrical signal to the local information processing device 2000. It is noted that the optical module is a tool for achieving the mutual conversion between optical and electrical signals, and during the conversion between optical and electrical signals as described above, the information is not changed, but methods for encoding and decoding the information may be changed.

The host computer 100 includes not only an optical network unit but also an optical line terminal (OLT), an optical network terminal (ONT), or a data center server or the like.

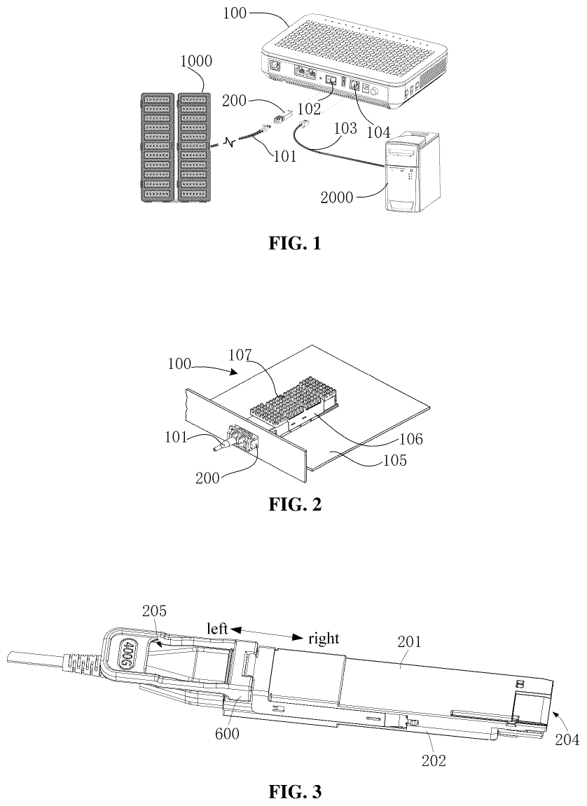

FIG. 2 is a partial structural diagram of a host computer according to some embodiments of this disclosure. In order to illustrate a connection relationship between the optical module 200 and the host computer 100 clearly, FIG. 2 only shows the structure of the host computer 100 related to the optical module 200. As shown in FIG. 2, the host computer 100 further includes a PCB circuit board 105 disposed within the housing, a cage 106 disposed on a surface of the PCB circuit board 105, a radiator 107 disposed on the cage 106, and an electrical connector disposed inside the cage 106. The electrical connector is configured to be coupled to the electrical port of the optical module 200. The radiator 107 has a raised structure, such as a fin, that increases a heat dissipation area.

The optical module 200 is inserted into the cage 106 of the host computer 100 and then is secured by the cage 106. Thus, heat generated by the optical module 200 is conducted to the cage 106, and then dissipated via the radiator 107. After the optical module 200 is inserted into the cage 106, the electrical port of the optical module 200 is connected to the electrical connector inside the cage 106 such that a bidirectional electrical signal connection is established between the optical module 200 and the host computer 100. In addition, the optical port of the optical module 200 is connected to the optical fiber 101, such that the optical module 200 establishes a bidirectional optical signal connection with the optical fiber 101.

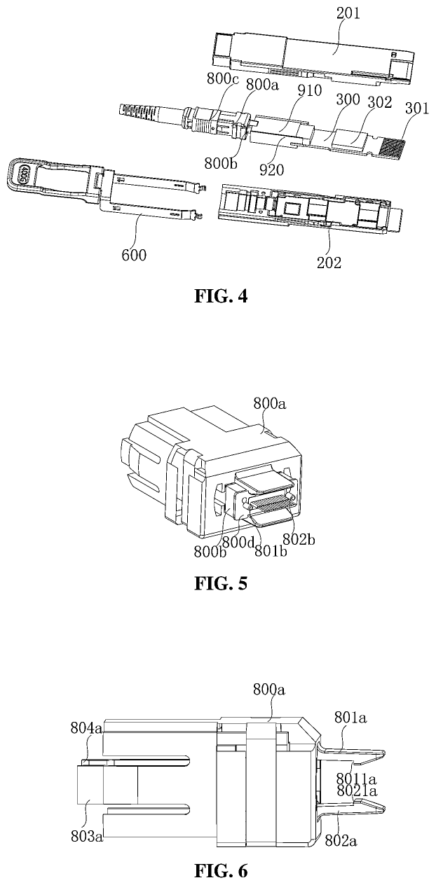

FIG. 3 is a structural diagram of an optical module according to some embodiments of this disclosure, and FIG. 4 is an exploded diagram of an optical module according to some embodiments of this disclosure. As shown in FIG. 3 and FIG. 4, the optical module 200 includes a shell, a circuit board 300, and an optical emission component and an optical reception component that are disposed within the shell. However, this disclosure is not limited to this. In some embodiments, the optical module 200 may include one of the optical emission component and the optical reception component.

The shell may include an upper shell part 201 and a lower shell part 202. The upper shell part 201 is covered on the lower shell part 202 to form the aforementioned shell having two openings 204 and 205. An outer contour of the shell is generally in a cuboid shape.

In some embodiments, the lower shell part 202 includes a bottom plate 2021 and two lower side plates 2022 located at opposite sides of the bottom plate 2021 and disposed perpendicular to the bottom plate 2021, and the upper shell part 201 includes a cover plate 2011 which is covered on the two lower side plates 2022 of the low shell part 202 so as to form the above-mentioned shell.

In some embodiments, the lower shell part 202 includes a bottom plate 2021 and two lower side plates 2022 located on opposite sides of the bottom plate 2021 and disposed perpendicular to the bottom plate 2021; the upper shell part 201 includes a cover plate 2011 and two upper side plates located on opposite sides of the cover plate 2011 and disposed perpendicular to the cover plate 2011, and the two upper side plates are combined with the two lower side plates 2022 such that the upper shell part 201 is covered on the lower shell part 202.

A direction along a connecting line between the two openings 204 and 205 may be consistent with a length direction of the optical module 200 or inconsistent with the length direction of the optical module 200. For example, the opening 204 is located at an end of the optical module 200 (right end in FIG. 3), and the opening 205 is also located at an end of the optical module 200 (left end in FIG. 3). Alternatively, the opening 204 is located at an end of the optical module 200, while the opening 205 is located at a side of the optical module 200. The opening 204 is an electrical port, and gold finger 301 of the circuit board 300 extends out of the opening 204 and is inserted into the electrical connector of the host computer 100. The opening 205 is an optical port configured to be coupled by the optical fiber 101 such that the optical fiber 101 is connected with the optical emission component and the optical reception component of the optical module 200.

The assembling way in which the upper shell part 201 is combined with the lower shell part 202 facilitates mounting the circuit board 300, the optical emission component, the optical reception component or the like into the above-mentioned shell, such that these components are encapsulated and protected by the upper shell part 201 and the lower shell part 202. In addition, when assembling the circuit board 300, the optical emission component, the optical reception component or the like, it is easier to deploy positioning elements, heat dissipation elements, and electromagnetic shielding elements of these components, which facilitates automate production implementation.

In some embodiments, the upper shell part 201 and the lower shell part 202 are made of metal material(s), which facilitates to achieving electromagnetic shielding and heat dissipation.

In some embodiments, the optical module 200 further includes an unlocking component 600 located outside the shell thereof. The unlocking component 600 is configured to achieve a fixed connection between the optical module 200 and the host computer or to release the fixed connection between the optical module 200 and the host computer.

For example, the unlocking component 600 is located outside the two lower side plates 2022 of the lower shell part 202, and includes a snapping part that matches with the cage 106 of the host computer. When the optical module 200 is inserted into the cage 106, the snapping part of the unlocking component 600 secures the optical module 200 within the cage 106. As the unlocking component 600 is pulled, the snapping part of the unlocking component 600 moves accordingly, and thus the connection relationship between the snapping part and the host computer is changed, thereby releasing the optical module 200 from the host computer, such that the optical module 200 can be drawn out of the cage 106.

The circuit board 300 includes circuit wiring, electronic elements, chips, and so on. The electronic elements and chips are connected together via the circuit wiring according to a circuit design so as to achieve various functions such as power supply, electrical signal transmission, and grounding. For example, the electronic element may include a capacitor, a resistor, a transistor, and a Metal-Oxide-Semiconductor Field-Effect Transistor (MOSFET). For example, the chip may include a microcontroller unit (MCU), a laser driver chip, a transimpedance amplifier (TIA), a limiting amplifier (LA), a Clock and Data Recovery (CDR) chip, a power management chip, and a digital signal processing (DSP) chip.

The circuit board 300 is generally a rigid circuit board. Also, the rigid circuit board may achieve a carrying function due to its relatively hard material. For example, the rigid circuit board may steadily carry the above-mentioned electronic elements and chips thereon. Furthermore, the rigid circuit board may be easily inserted into the electrical connector inside the cage 106 of the host computer 100.

The circuit board 300 further includes a gold finger 301 formed on a surface of an end thereof, which is composed of multiple independent pins. The circuit board 300 is inserted into the cage 106 and is conductively connected to the electrical connector inside the cage 106 via the golden finger 301. The golden finger 301 may be disposed only on a surface of one side of the circuit board 300 (e.g., an upper surface shown in FIG. 4), or on surfaces of upper and lower sides of the circuit board 300 to provide a larger number of pins, so as to adapt to occasions where a large number of pins are required. The golden finger 301 is configured to establish an electrical connection with the host computer to achieve power supply, grounding, Inter-Integrated Circuit (I2C) signal transmission, data signal transmission or the like. Of course, it is possible to use a flexible circuit board in some optical modules. The flexible circuit board is generally used in cooperation with the rigid circuit board to serve as a supplement to the rigid circuit board.

At least one of the optical emission component and the optical reception component are located at a side of the circuit board 300 away from the golden finger 301.

In some embodiments, the optical emission component and the optical reception component each are physically separated from the circuit board 300, and then electrically connected to the circuit board 300 via a respective flexible circuit board or electrical connector.

In some embodiments, at least one of the optical emission component and the optical reception component may be directly disposed on the circuit board 300. For example, at least one of the optical emission component and the optical reception component may be disposed on a surface of the circuit board 300 or a side of the circuit board 300.

In some embodiments, a DSP chip 302 is also provided on the surface of the circuit board 300. The electrical signal is input from the electrical interface unit, and the DSP chip 302 performs preprocessing and signal modulation on the electrical signal, outputs the modulated electrical signal, and loads it onto the driver chip. The driver chip transmits the modulated electrical signal to the laser chip, and the laser chip converts the modulated electrical signal into an optical signal, thereby obtaining an optical emission signal carrying data. In the present disclosure, the surface of the circuit board 300 provided with the DSP chip 302 may be referred to as the front surface, and the other surface of the circuit board 300 opposite to the front surface may be referred to as the back surface.

The circuit board 300 is electrically connected to an optical transceiver cavity. For example, one end of the circuit board 300 is inserted into the optical transceiver cavity. The optical transceiver cavity is configured to arrange various optical elements of the optical reception end (or the optical reception component) and various optical elements of the optical emission end (or the optical emission component) therein. The optical emission component and the optical reception component of multiple optical paths are properly arranged inside the optical transceiver cavity so as to realize multi-optical path transmission and improve the transmission rate.

In order to transmit the optical signal, one side of the optical transceiver cavity that is provided with the optical port is connected to one end of an optical fiber plug 800b, and the other end of the optical fiber plug 800b is connected to an optical fiber connector 800c. The optical fiber connector 800c is connected to an external optical fiber; and the side of the optical transceiver cavity that is provided with the optical port is connected to an internal optical fiber. The external optical fiber and the internal optical fiber are connected through the optical fiber plug 800b so as to transmit the optical signal. For example, an optical reception signal to be transmitted to the optical reception end is transmitted to the optical transceiver cavity through the external optical fiber, the optical fiber connector 800c, the optical fiber plug 800b, and the internal optical fiber in sequence, and then is transmitted to the optical reception component; an optical emission signal generated by the optical emission end is transmitted out of the optical transceiver cavity through the internal optical fiber, the optical fiber plug 800b, the optical fiber connector 800c and the external optical fiber in sequence, and then is transmitted out of the optical module.

In some embodiments, an interface claw member 800a is configured to couple the optical fiber connector 800c and the optical fiber plug 800b, the optical fiber connector 800c is further connected to an external optical fiber, an end of the optical fiber plug 800b is connected to an internal optical fiber, the optical fiber connector 800c is inserted into one end of the interface claw member 800a, and thus the optical fiber plug 800b is inserted into the other end of the interface claw member 800a, and the optical fiber connector 800c and the optical fiber plug 800b are coupled inside the interface claw member 800a, thereby achieving optical coupling of the internal optical fiber and the external optical fiber.

FIG. 5 is a schematic diagram of an interface claw member and an optical fiber plug according to some embodiments of the present disclosure in an assembly state; FIG. 6 is a structural diagram of an interface claw member according to some embodiments of the present disclosure. As shown in FIG. 5 and FIG. 6, one end of the interface claw member 800a is provided with a first claw 801a and a second claw 802a in a vertical direction. The first claw 801a and the second claw 802a are arranged oppositely, the optical fiber plug 800b is arranged between the first claw 801a and the second claw 802a, and the first claw 801a and the second claw 802a are respectively snap fitted in the above-mentioned optical transceiver cavity, such that one end of the interface claw member 800a is connected to the optical transceiver cavity. The other end of the interface claw member 800a is provided with a third claw 803a and a fourth claw 804a in a horizontal direction. The third claw 803a and the fourth claw 804a are respectively engaged on the optical fiber connector 800c, such that the other end of the interface claw member 800a is connected to the optical fiber connector 800c.

In some embodiments, an inner surface of the first claw 801a is recessed upward to form a first limiting portion 8011a, and an inner surface of the second claw 802a is recessed downward to form a second limiting portion 8021a.

In order to prevent the optical fiber plug 800b from falling out of the interface claw member 800a, a limiting piece 800d is provided at an end of the optical fiber plug 800b. The limiting piece 800d is located between the first limiting portion 8011a and the second limiting portion 8021a, and the first limiting portion 8011a and the second limiting portion 8021a respectively clamp the limiting piece 800d to thereby hold the limiting piece 800d. The limiting piece 800d in turn abuts against the optical fiber plug 800b to limit the optical fiber plug 800b in the interface claw member 800a, thereby preventing the optical fiber plug 800b from falling out of the interface claw member 800a and limiting the optical fiber plug 800b.

In some embodiments, one end of the optical fiber plug 800b is formed with a first pin 801b and a second pin 802b, and the first pin 801b and the second pin 802b are configured to connect with the above-mentioned optical transceiver cavity. An inner optical fiber passes through one end of the optical fiber plug 800b, and is arranged between the first claw 801a and the second claw 802a. One end of the internal optical fiber is led out from the end of the optical fiber plug 800b, and the other end thereof is extended into the above-mentioned optical transceiver cavity to realize transmission of optical signal with internal optical elements. In view of the configuration of the optical fiber plug 800b, for example, the limiting piece 800d is configured to include corresponding through holes configured to avoid or make way for the first pin 801b and the second pin 802b, and corresponding through holes configured to avoid or make way for the internal optical fiber.

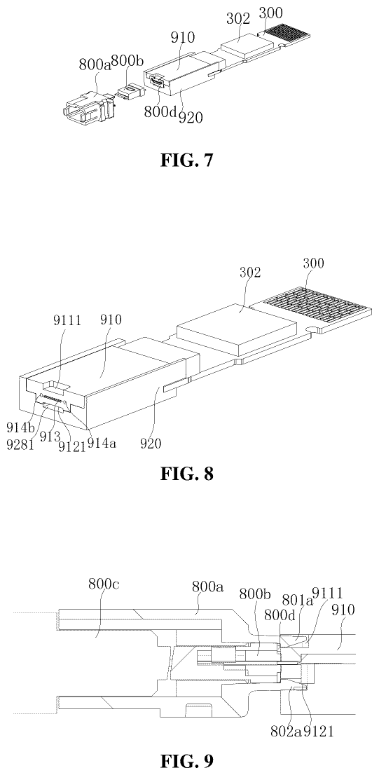

FIG. 7 is a schematic view of an interface claw member and an optical fiber plug according to some embodiments of the present disclosure in a disassembled state. As shown in FIG. 7, in some embodiments, the optical transceiver cavity includes a cover shell 910 and a base 920 that are connected together, wherein the cover shell 910 is embedded between two side walls of the base 920.

After the optical fiber plug 800b is connected to the optical transceiver cavity, the limiting piece 800d will abut against an end surface of the cover shell 910. At this time, the limiting piece 800d is located between the optical fiber plug 800b and the end surface of the cover shell 910 and the base 920.

FIG. 8 is a schematic view illustrating a cover shell and a base according to some embodiments of the present disclosure in an assembly state. As shown in FIG. 8, an optical fiber port 913 is formed on an end edge of the cover shell 910, and the optical fiber plug 800b is optically coupled to the optical fiber port 913, such that the internal optical fiber extended from the optical fiber plug 800b passes through the optical fiber port into the cover shell 910, and establishes an optical connection with optical element(s) inside the cover shell 910.

A first insertion hole 914a and a second insertion hole 914b are respectively formed at opposite sides of the optical fiber port 913 such that the first pin 801b and the second pin 802b are respectively inserted therein, thereby coupling the optical fiber plug 800b with the cover shell 910 together to achieve connection therebetween.

The optical fiber plug 800b connected with the internal optical fiber is arranged between the first claw 801a and the second claw 802a, the first claw 801a and the second claw 802a are arranged opposite to each other in the vertical direction, and the internal optical fiber needs to be optically coupled with the optical fiber port 913, in view of this, the cover shell 910 is formed thereon with a first matching portion 9111 and a second matching portion 9121, which are arranged on upper and lower sides of the optical fiber port 913 and are arranged opposite to each other in the vertical direction. In some embodiments, the first claw 801a is inserted in the first matching portion 9111, and the second claw 802a is inserted in the second matching portion 9121, such that the interface claw member 800a is fixedly connected to the cover shell 910 to achieve the connection between the two. In some embodiments, if thickness of each of the first claw 801a and the second claw 802a is relatively large, the first matching portion 9111 may have a larger depth to receive the first claw 801a, and a third matching portion 9281 may be provided opposite to the second matching portion 9121 so as to avoid or make way for the second claw 802a through the third matching portion 9281 to provide a larger space for the engaging of the second claw 802a. At this time, the second claw 802a is located between the second matching portion 9121 and the third matching portion 9281.

FIG. 9 is a sectional view illustrating an interface claw member provided according to the present application in an assemble state. Referring to FIG. 9, in some embodiments, an optical waveguide substrate 900a is arranged inside the cover shell 910, and the optical waveguide substrate 900a includes an optical waveguide configured to transmit an optical reception signal and an optical emission signal. Wherein, the optical reception signal is an optical signal to be transmitted to the optical reception end, and the optical emission signal is an optical signal generated by the optical emission end. The optical fiber port 913 is arranged between the optical fiber plug 800b and the optical waveguide substrate 900a, one side of the optical fiber port 913 is optically coupled to the optical fiber plug 800b, and the other side thereof is optically coupled to the optical waveguide substrate 900a. As an example, the optical fiber port 913 is optically connected to an optical port of the optical waveguide substrate 900a, and one end of the internal optical fiber is guided out of the optical fiber plug 800b, while the other end of the internal optical fiber passes through the optical fiber port 913 which is optically connected to the optical fiber plug 800b, until the other end of the internal optical fiber extends to the optical port of the optical waveguide substrate 900a, thereby optically connecting the internal optical fiber with the optical waveguide substrate 900a to achieve transmission of the optical signal.

In the present disclosure, the optical fiber plug 800b is arranged between the first claw 801a and the second claw 802a, and the optical fiber port is arranged between the first matching portion 9111 and the second matching portion 9121. When the optical fiber plug 800b is optically connected to the optical fiber port 913, the first claw 801a is connected to the first matching portion 9111, and the second claw 802a is connected to the second matching portion 9121. In this way, when the optical fiber plug 800b is coupled with the optical fiber port 913, the interface claw member 800a is also fixedly connected on the cover shell 910.

As shown in FIG. 9, in some embodiments of the present disclosure, since an optical waveguide substrate 900a is arranged in the cover shell 910, an optical fiber port 913 is formed at an end of the cover shell 910, and the optical fiber port 913 is optically connected to the optical waveguide substrate 900a, and the internal optical fiber is arranged between the first claw 801a and the second claw 802a which are arranged opposite to each other in the vertical direction, it needs that the internal optical fiber be optically connected to the optical fiber port 913, such that the internal optical fiber passes through the optical fiber port 913 to be optically connected to the optical waveguide substrate 900a. Therefore, a first matching portion 9111 and a second matching portion 9121 are respectively formed at the end of the cover shell 910, for example, at upper and lower sides of the optical fiber port 913, such that the first claw 801a located above the internal optical fiber is engaged in the first matching portion 9111 located above the optical fiber port 913, and the second claw 802a located below the internal optical fiber is engaged in the second matching portion 9121 located below the optical fiber port 913, thereby simultaneously realizing optical coupling between the internal optical fiber and the optical fiber port 913, and connection between the interface claw member 800a and the cover shell 910.

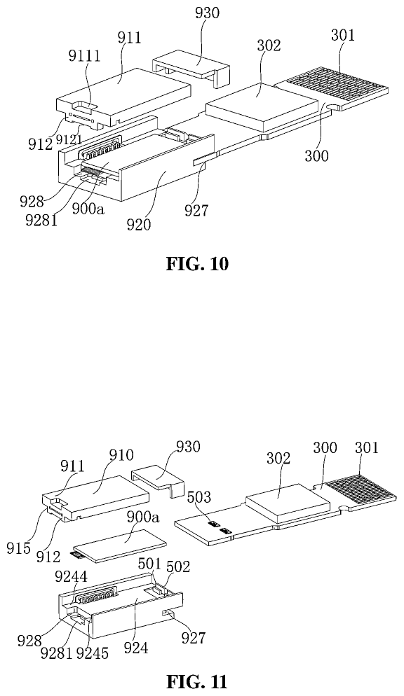

FIG. 10 is a partial exploded schematic diagram of an optical module provided according to some embodiments of the present disclosure. As shown in FIG. 10, in some embodiments, the optical transceiver cavity includes a cover shell 910 and a base 920 that are connected to each other. Two side walls of the base 920 are each convex relative to its surface, such that the cover shell 910 is arranged between the two side walls of the base 920.

The optical waveguide substrate 900a is arranged between the cover shell 910 and the base 920. Exemplarily, the cover shell 910 has an accommodation cavity for enclosing the optical waveguide substrate 900a. Therefore, the optical waveguide substrate 900a is disposed on the surface of the base 920 and is covered and enclosed by the cover shell 910.

In some embodiments, the cover shell 910 includes a main body 911, which is configured to cover and enclose the optical waveguide substrate 900a. Since the optical fiber plug 800b is optically connected to the optical waveguide substrate 900a, and the optical fiber plug 800b is arranged between the first claw 801a and the second claw 802a disposed opposite to each other, the first matching portion 9111 and the second matching portion 9121 should be disposed on upper and lower sides of the optical waveguide substrate 900a, respectively. Since the main body 911 is arranged above the optical waveguide substrate 900a, the first matching portion 9111 is formed on a surface of the main body 911. As described above, a surface of the first claw 801a is recessed upwards to form the first limiting portion 8011a, and a surface of the second claw 802a is recessed downwards to form the second limiting portion 8021a. In order to achieve limitation and fixation of the first claw 801a and the second claw 802a, the upper surface of the main body 911 is recessed downwards to form the first matching portion 9111 to match the first claw 801a; and the second matching portion 9121 is recessed upward at a certain position to match the second claw 802a. A distance between the first claw 801a and the second claw 802a is less than the thickness of the base 920, so it is not suitable for the second matching portion 9121 which is recessed upwards to be disposed on the base 920. In this consideration, the second matching portion 9121 may be disposed on the cover shell 910. Further, since the thickness of the main body 911 covering the optical waveguide substrate 900a is smaller than the distance between the first claw 801a and the second claw 802a, one end of the main body 911 may be extended downwards to form an extension plate 912, and a bottom portion of the extension plate 912 may be recessed upwards to form the second matching portion 9121. At the same time, the optical fiber port 913 may be disposed on a surface of the extension plate 912, such that the optical fiber port 913 is located between the first matching portion 9111 and the second matching portion 9121.

In the present disclosure, a support groove 928 is disposed at an end of the base 920, and the extension plate 912 is embedded in the support groove 928 so as to connect the cover shell 910 and the base 920. Exemplarily, in the case that the thickness of the second claw 802a is large, a surface of the support groove 928 may be recessed downwards to form the third matching portion 9281, and the third matching portion 9281 is arranged opposite to the second matching portion 9121 to avoid or make way for the second claw 802a, providing a larger space for the engaging of the second claw 802a.

The optical waveguide substrate 900a is arranged between the cover shell 910 and the base 920, and the optical waveguide substrate 900a is optically connected to the optical fiber port 913. The internal optical fiber is led out from an end of the optical fiber plug 800b, passed through the optical fiber port 913, and is directly connected to the optical waveguide substrate 900a, thereby realizing optical coupling between the optical fiber plug 800b and the optical waveguide substrate 900a, so as to transmit the optical signal through the internal optical fiber. For instance, the optical reception signal is transmitted to the optical reception end through the external optical fiber, the optical fiber connector 800c, the optical fiber plug 800b, the internal optical fiber and optical channel in the optical waveguide substrate 900a in sequence; and the optical transmission signal is transmitted outside of the optical module through the optical channel in the optical waveguide substrate 900a, the internal optical fiber, the optical fiber plug 800b, the optical fiber connector 800c, and the external optical fiber in sequence.

An opening 927 is formed at one end of the base 920 to allow the circuit board 300 to be inserted into the base 920. The circuit board 300 is then electrically connected to the light reception end and the light emission end, respectively, so as to transmit electrical signals.

A gold finger 301 is disposed at one end of the circuit board 300, and a DSP chip 302 is provided on a surface of the circuit board. The other end of the circuit board 300 is inserted into the optical transceiver cavity so as to transmit the electrical signal to the optical emission end or transmit the electrical signal generated by the optical reception end to the host computer through the gold finger 301. In the present disclosure, the surface of the circuit board 300 provided with the DSP chip 302 is referred to as the front surface of the circuit board 300, and the opposite surface is referred to as the back surface of the circuit board 300. Exemplarily, the front surface of the circuit board 300 is provided with some optical elements of the optical reception end, and the back surface of the circuit board 300 is electrically connected to electrical elements of the optical emission end.

In some embodiments, since the DSP chip 302 generates a large amount of heat in operation, the DSP chip 302 may be disposed on the front surface of the circuit board 300. In this case, since the front surface of the circuit board 300 is covered with the upper shell part 201, heat generated by the DSP chip 302 can be dissipated through the upper shell part 201. Of course, the DSP chip can also be disposed on the back surface of the circuit board 300.

FIG. 11 is a second partial exploded schematic diagram of an optical module provided according to some embodiments of the present disclosure. As shown in FIG. 11, in some embodiments, a surface of the extension plate 912 is disposed with the optical fiber port 913 and the second matching portion 9121. The optical fiber port 913 is configured to be optically coupled to the optical waveguide substrate 900a, and the internal optical fiber may pass through the optical fiber port 913 until it extends into the optical waveguide substrate 900a. With the arrangement of the extension plate 912, a surface of the base 920 at one end thereof is recessed downwards to form the support groove 928. The extension plate 912 is embedded in the support groove 928, thereby connecting the cover shell 910 to the base 920.

In this disclosure, bottom portion of the extension plate 912 is to be recessed upward so as to form the second matching portion 9121, leaving a small support area between the extension plate 912 and the support groove 928. In order to increase the support area between the extension plate 912 and the support groove 928 to facilitate positioning, the extension plate 912 is designed to have a smaller width than that of the main body 911, so as to form connecting portions 915 between the extension plate 912 and the main body 911 at both sides of the extension plate. Correspondingly, the support groove 928 has a width smaller than that of the surface of the base 920, such that a first support portion 9244 and a second support portion 9245 are respectively formed at both sides of the support groove 928, in this way, the connecting portion 915 at one side of the extension plate is connected to the first support portion 9244, and the connecting portion 915 at the other side of the extension plate is connected to the second support portion 9245, thereby increasing the supporting surface between the extension plate 912 and the support groove 928, and realizing limiting and connection between the cover shell 910 and the base 920.

In the present disclosure, an optical reception chip 503 is arranged at one side of the optical waveguide substrate 900a that is provided with an output optical port. For example, multiple optical reception chips 503 are arranged on the surface of the circuit board 300 in an array. Since the circuit board is inserted into the base 920, and the optical waveguide substrate is located on the surface of the base 920, the optical waveguide substrate is located at a higher level than that of the optical reception chip 503. In view of this, in some embodiments, a turning prism 502 may be arranged in front of the optical reception chip 503. The turning prism 502 is arranged at a light output end of the optical waveguide substrate to receive the optical reception signal output from the optical waveguide substrate, and reflect the optical reception signal toward the optical reception chip 503 such that the optical reception signal is transmitted to the optical reception chip 503.

By way of example, the optical reception chip 503 is disposed on the front surface of the circuit board 300, the turning prism 502 is located at the output optical port of the optical waveguide substrate 900a, the surface of the base 920 is relatively higher than the front surface of the circuit board 300, and a light exiting surface of the turning prism 502 faces the optical reception chip 503. Thus, the turning prism 502 can turn the optical signal output from the optical waveguide substrate 900a toward the optical reception chip 503, thereby turning the optical reception signal to the surface of the optical reception chip 503.

In some embodiments, a second lens 501 is arranged between the output optical port of the optical waveguide substrate 900a and the turning prism 502. Exemplarily, the second lens 501 is a converging lens, which can converge the optical signal output from the optical waveguide substrate 900a to reduce power loss of the reception light, and then transmit it to the turning prism 502.

In some embodiments, a TIA 504 (see FIG. 23) is arranged on the surface of the circuit board 300 in the output optical path of the optical reception chip 503. The TIA 504 is provided to convert photocurrent signal generated by the optical reception chip 503 into voltage signal and to amply the voltage signal.

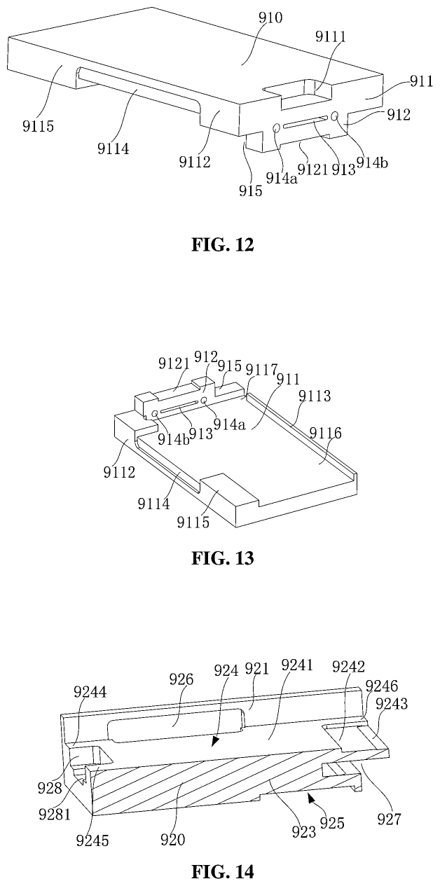

FIG. 12 is a first structural diagram of a cover shell provided according to some embodiments of the present disclosure; FIG. 13 is a second structural diagram of a cover shell provided according to some embodiments of the present disclosure. As shown in FIG. 12 and FIG. 13, the cover shell 910 includes the main body 911, a surface of the main body 911 is recessed downward to form the first matching portion 9111, one end of the main body 911 is extended downward to form the extension plate 912, and surface(s) of the extension plate 912 is configured to be provided with the optical fiber port 913 and the second matching portion 9121. Exemplarily, the bottom portion of the extension plate 912 is recessed upward to form the second matching portion 9121.

An end of the optical fiber plug 800b is formed with an optical fiber port, through which the internal optical fiber is extended. The optical fiber port of the optical fiber plug is optically coupled with the optical fiber port 913, and the internal optical fiber passes through the optical fiber port 913 until it extends to the optical port of the optical waveguide substrate 900a. The first pin 801b and the second pin 802b are respectively provided at both sides of the optical fiber port of the optical fiber plug 800b. Correspondingly, the first insertion hole 914a and the second insertion hole 914b are respectively formed at both sides of the optical fiber port 913. The first pin 801b is inserted into the first insertion hole 914a, and the second pin 802b is inserted into the second insertion hole 914b, so as to realize connection between the optical fiber plug 800b and the cover shell 910.

For example, the main body 911 includes a first side wall 9112 and a second side wall 9113 that are arranged opposite to each other. An avoidance groove 9114 is formed in and passes through the middle portion of the first side wall 9112, and a boss 9115 is formed on one side of the first side wall 9112.

In an example, an accommodation cavity 9116 is formed between the first side wall 9112 and the second side wall 9113 to enclose and receive the optical waveguide substrate 900a. In order to facilitate disassembling of the optical waveguide substrate 900a for repairing, the second side wall 9113 is formed, at one side thereof, with a notch 9117, such that the optical waveguide substrate 900a can be taken out for repairing with certain actions performed at the notch 9117.

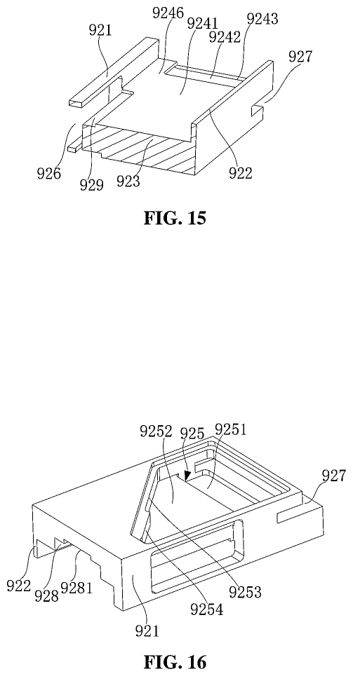

FIG. 14 is a first structural diagram of a base provided according to some embodiments of the present disclosure; FIG. 15 is a second structural diagram of a base provided according to some embodiments of the present disclosure. As shown in FIG. 14 and FIG. 15, in some embodiments, the base 920 includes a third side wall 921 and a fourth side wall 922, the surface of the base 920 is recessed relative to the third side wall 921 and the fourth side wall 922, and a distance between the third side wall 921 and the fourth side wall 922 is greater than a distance between the first side wall 9112 and the second side wall 9113, such that the cover shell 910 is disposed between the third side wall 921 and the fourth side wall 922.

The base 920 has a layered structure, in particular, the base 920 is formed, at a middle portion thereof, with a partition part 923, with which the base 920 is partitioned into an upper space 924 located above the partition part 923 and a lower space 925 located below the partition part 923. The upper space 924 and the lower space 925 are separated by the partition part 923. The upper space 924 is configured so as to arrange the optical waveguide substrate 900a, the second lens 501, and the turning prism 502; and the lower space 925 is configured so as to arrange optical elements of the optical emission component. The turning prism 502 is arranged on a surface of the partition part 923. For example, the turning prism 502 is located in the upper space 924.

Since the optical waveguide substrate 900a, the second lens 501, and the turning prism 502 are all located in the upper space 924, the transmission of the optical reception signal is in the same layer. In this way, optical signal output from the optical waveguide substrate 900a is transmitted in the same layer to the second lens 501 and the turning prism 502, there is no need for the transmission optical path of the optical reception signal to be switched and guided between the upper and lower spaces, and the optical reception optical path is simple, thereby reducing optical power loss.

The upper space 924 includes a first surface 9241, a fourth surface 9242 and a third surface 9243. The first surface 9241, the fourth surface 9242 and the third surface 9243 are located on the top portion of the partition part 923, wherein the optical waveguide substrate 900a is located between the cover shell 910 and the first surface 9241; the fourth surface 9242 is configured to arrange the second lens 501, and the third surface 9243 is configured to arrange the turning prism 502. In an exemplary example, the fourth surface 9242 may be located at a higher level than the third surface 9243 such that optical axes of the second lens 501 and the turning prism 502 are on the same axis.

The opening 927 is formed at one end of the partition part 923 such that the circuit board 300 can be inserted into the partition part 923. The front surface of the circuit board 300 can be configured to carry the optical reception chip 503 and the TIA 504, so as to establish electrical connection with the optical reception component. The circuit board 300 is extended to the optical emission component, so as to establish electrical connection with the optical emission component.

The first surface 9241 includes a surface configured to support the optical waveguide substrate 900a, and also includes the first support portion 9244, the second support portion 9245 and a third support portion 9246. The first support portion 9244 and the second support portion 9245 are located on an optical port side of the optical transceiver cavity, and the third support portion 9246 is located on an electrical port side of the optical transceiver cavity.

The support groove 928 is arranged between the first support portion 9244 and the second support portion 9245. The support groove 928 is U-shaped and is recessed relative to the surface of the base 920. Exemplarily, the support groove 928 is recessed relative to the surface of the first surface 9241, such that the extension plate 912 is arranged in the support groove 928, and the connecting portions 915 at both sides abut on the first surface 9241. For example, the connecting portions 915 on both sides abut on the first support portion 9244 and the second support portion 9245, respectively, such that the extension plate 912 is inserted in the support groove 928. The support groove 928 supports the extension plate 912, and the connecting portions 915 match and abut with the first support portion 9244 and the second support portion 9245, realizing limiting and connection between the cover shell 910 and the base 920.

In some embodiments, a second surface 929 is formed on one side of the first surface 9241 close to the third sidewall 921. Exemplarily, the second surface 929 is recessed relative to the first surface 9241.

In some embodiments, the third side wall 921 is hollowed out to form a hollowed portion 926, which is a through hole. The hollowed portion 926 exposes upper and lower surfaces of the partition part 923. As an example, a height of the hollowed portion 926 is greater than a height of the partition part 923, such that the upper and lower surfaces of the partition part 923 are exposed from the hollowed portion 926.

FIG. 16 is a third structural diagram of a base provided according to some embodiments of the present disclosure. As shown in FIG. 16, a surface of the lower space 925 is recessed to different degrees toward the upper space 924, forming a first recessed portion 9251 and a second recessed portion 9252. The first recessed portion 9251 and the second recessed portion 9252 are located on the bottom portion of the partition part 923. By way of example, the first recessed portion 9251 and the second recessed portion 9252 are configured to arrange optical elements of the optical emission component, and the first recessed portion 9251 is further recessed relative to the second recessed portion 9252. One side of the second recessed portion 9252 is connected to a first vertical surface 9253 and a second vertical surface 9254.

The first recessed portion 9251 and the second recessed portion 9252 are respectively configured to arrange optical elements of the optical emission component.

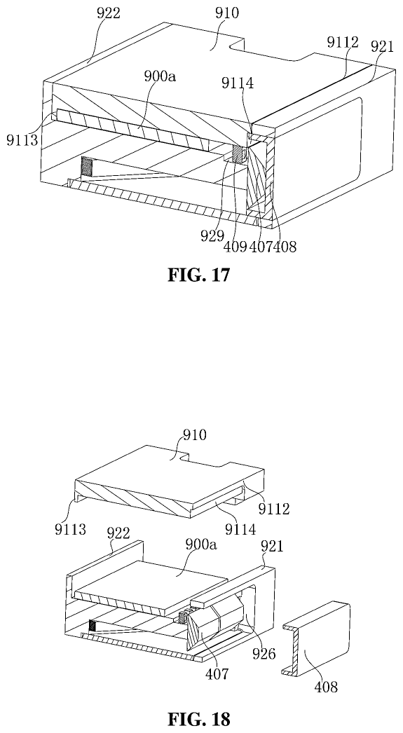

FIG. 17 is a first schematic sectional view of an assembly of a cover shell and a base according to some embodiments of the present disclosure. As shown in FIG. 17, the width between the third side wall 921 and the fourth side wall 922 of the base 920 is relatively larger than the width between the first side wall 9112 and the second side wall 9113 of the cover shell 910, and then the cover shell 910 is arranged between the third side wall 921 and the fourth side wall 922. The surface of the cover shell 910 may be flush with surfaces of the third side wall 921 and the fourth side wall 922.

The optical waveguide substrate 900a is arranged between the cover shell 910 and the base 920. For example, the optical waveguide substrate 900a is located between the cover shell 910 and the upper space 924 of the base 920. The second side wall 9113 of the cover shell 910 encloses the optical waveguide substrate 900a. A width of the optical waveguide substrate 900a is smaller than the width between the first side wall 9112 and the second side wall 9113. In this case, one side of the optical waveguide substrate 900a may be at a distance from the second side wall 9113 so as to facilitate design and adjustment of the optical path. In some packaging processes, the optical waveguide substrate 900a needs to be fixed first. For example, the optical waveguide substrate 900a can be enclosed by the cover shell 910 so as to be fixed.

Since the optical waveguide substrate 900a is located in the upper space 924, while the optical elements of the optical emission component is located in the lower space 925, the transmission of the optical emission signal is cross-layer transmission, and it needs to switch and guide the transmission optical path of the optical emission signal in the height. For example, the transmission direction of the optical emission signal is turned towards the upper space 924, such that the output direction of the optical emission signal is toward the optical waveguide substrate 900a, and finally is transmitted into the optical waveguide substrate 900a. In some embodiments, by setting a displacement prism 407, the transmission direction of the optical emission signal may be turned toward the upper space 924, such that the output direction of the optical emission signal is guided to the optical waveguide substrate 900a, and the optical emission signal is transmitted into the optical waveguide substrate 900a.

In some embodiments, the displacement prism 407 is arranged in the hollowed portion 926. Exemplarily, the displacement prism 407 may be disposed in a fixing frame 408, and then the fixing frame 408 is embedded in the hollowed portion 926, such that the displacement prism 407 is embedded in the hollowed portion 926, thereby fixing the displacement prism 407.

In some embodiments, the fixing frame 408 is a frame with an opening. For example, it may include a top portion, a bottom portion and a side portion connecting the top portion and the bottom portion. The displacement prism 407 is arranged between the top portion and the bottom portion, such that the displacement prism 407 is clamped by the top portion and the bottom portion, and is fixed by the side portion.

In some embodiments, a width of the fixing frame 408 is relatively greater than a width of the third side wall 921, and thus an avoidance groove 9114 is formed in and extended through the middle portion of the first side wall 9112 of the cover shell 910 to avoid or make way for the fixing frame 408. Exemplarily, one side of the fixing frame 408 is connected to the avoidance groove 9114.

In some embodiments, the second side wall 9113 of the cover shell 910 is located between the fourth side wall 922 of the base 920 and the optical waveguide substrate 900a, and the first side wall 9112 is abutted on the third side wall 921.

FIG. 18 is a schematic diagram illustrating a disassembled state of a cover shell and a base according to some embodiments of the present disclosure. As shown in FIG. 18, the first side wall 9112 is formed, in the middle portion thereof, with an avoidance groove 9114 which extends through the middle so as to make way for the fixing frame 408. Exemplarily, one side of the fixing frame 408 is connected to the avoidance groove 9114. A hollowed portion 926 is formed in the third side wall 921 such that the fixing frame 408 is embedded therein.

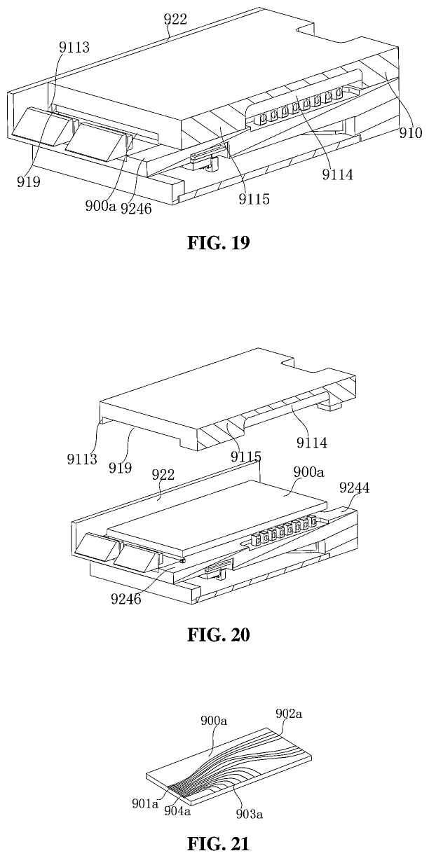

FIG. 19 is a second schematic sectional view of an assembly of a cover shell and a base according to some embodiments of the present disclosure; FIG. 20 is a second schematic view illustrating a disassembled state of a cover shell and a base according to some embodiments of the present disclosure. As shown in FIG. 19 and FIG. 20, the avoidance groove 9114 is formed and extended through the middle portion of the first side wall 9112, and a boss 9115 is formed on one side of the first side wall 9112. The boss 9115 is connected to part area of the third support portion 9246, and part surface of the third support portion 9246 is configured to support the boss 9115. The cover shell 910 is formed, at a side thereof facing the upper space, with an accommodation cavity 919 to receive the optical waveguide substrate 900a.

FIG. 21 is a schematic structural diagram of an optical waveguide substrate provided according to some embodiments of the present disclosure. As shown in FIG. 21, in some embodiments, a first input optical port 901a and a second output optical port 904a are respectively formed on one side of the optical waveguide substrate 900a close to the optical fiber plug 800b, a first output optical port 902a is formed on one side of the optical waveguide substrate 900a opposite to the first input optical port 901a, and a second input optical port 903a is formed on one side of the optical waveguide substrate adjacent to the second output optical port 904a.

The first input optical port 901a is communicated to the first output optical port 902a, and multiple optical channels are provided between the two to realize the transmission of multiple paths of optical signals. The optical channels between the first input optical port 901a and the first output optical port 902a are configured to transmit the external optical signals, that is, the optical reception signals, to the optical reception component.

The second input optical port 903a is communicated to the second output optical port 904a, and multiple optical channels are provided between the two to realize transmission of multiple optical signals. The optical channels between the second input optical port 903a and the second output optical port 904a are configured to transmit the optical signals generated by the optical emission component, that is, the optical emission signals, to the outside of the optical module.

The first input optical port 901a and the first output optical port 902a disposed on the opposite sides are configured to transmit optical reception signals; and the second input optical port 903a and the second output optical port 904a disposed on the adjacent sides are configured to transmit optical emission signals.

The first input optical port 901a and the first output optical port 902a are located on opposite sides, and the optical reception chip 503 is located at the first output optical port 902a. A light incident direction of the optical reception chip 503 is consistent with an output direction of the optical signal of the optical waveguide substrate 900a. That is, the output optical path direction of the optical waveguide substrate 900a is consistent with the input optical path direction of the optical reception chip 503, for example, both towards the optical port end of the optical module. Therefore, the optical signal output by the optical waveguide substrate 900a can be directly received by the optical reception chip 503, which reduces optical loss and is conducive to ensuring optical reception power.

The second input optical port 903a and the second output optical port 904a are located on two adjacent sides. A light emission direction of a laser chip of the optical emission component is inconsistent with an input direction of the optical waveguide substrate 900a, that is, the input optical path direction of the optical waveguide substrate 900a is inconsistent with the output optical path direction of the laser chip. For instance, the output optical path direction of the laser chip is toward the optical port, while the input optical path direction of the optical waveguide substrate 900a is toward the side. Therefore, the optical emission signal generated by the laser chip of the optical emission component needs to be turned and guided in the transmission direction so as to transmit the optical emission signal to the optical waveguide substrate 900a.

The first input optical port 901a and the second output optical port 904a are located on the same side. Exemplarily, the first input optical port 901a and the second output optical port 904a are both located on the side close to the optical fiber plug 800b, then reception light of the optical reception component and the emission light of the optical emission component are both arranged on one side, in other words, the reception light of the optical reception component enters the optical waveguide substrate 900a on this side, and the emission light of the optical emission component is output from the optical waveguide substrate 900a on the same side.

The first output optical port 902a and the second input optical port 903a are on different sides. Exemplarily, the first output optical port 902a and the second input optical port 903a are located on two adjacent sides. In the optical waveguide substrate 900a, the transmission starting point of the reception light and the transmission end point of the emission light are on the same side, and then the reception light is transmitted from the transmission starting point to the side opposite to the transmission starting point, while the transmission starting point of the emission light is located on a different side from the transmission end point of the emission light. Based on the reversibility of the optical path, it may be regarded that, in the present disclosure, the reception light and the emission light are converged on the same side, and then are dispersed and transmitted to different sides.

In the present disclosure, the transmission direction of the optical reception signal is consistent with the orientation of the optical port of the optical module, while the transmission direction of the optical emission signal is guided to the side of the optical waveguide substrate via the reflector and the displacement prism.

In the present disclosure, the input of the optical reception signal and the output of the optical emission signal converge on the same side, while the output of the optical reception signal and the input of the optical emission signal are dispersed on different transmission paths, and the transmission routes of the optical reception signal and the optical emission signal are reasonably arranged. In the present disclosure, the spaces of the cover shell and on the surface of the base are fully utilized, and the relative relationship between the optical waveguide substrate, the reception optical path and the emission optical path is reasonably arranged to realize the reception and emission of optical signals.

The fourth surface 9242 and the third surface 9243 are both located on the side of the optical waveguide substrate 900a provided with the first output optical port 902a, so as to transmit the optical signal output from the first output optical port 902a to the second lens 501 disposed on the fourth surface 9242 and to the turning prism 502 disposed on the third surface 9243 in sequence.

The second surface 929 is located at one side of the optical waveguide substrate 900a provided with the second input optical port 903a, so as to transmit the optical signal output by the optical element disposed on the second surface 929 to the second input optical port 903a, and then output it through the second output optical port 904a.

The hollowed portion 926 is also located on the side of the optical waveguide substrate 900a provided with the second input optical port 903a, so as to transmit optical signal output from optical element arranged in the hollowed portion 926 to the second input optical port 903a, and then output it through the second output optical port 904a.

By way of example, in a case that the optical module is an 800G optical module, the first input optical port 901a is communicated to the first output optical port 902a, and eight optical channels are arranged between the two, the eight optical channels are eight optical reception channels; the second input optical port 903a is communicated to the second output optical port 904a, and eight optical channels are also arranged between the two, and the eight optical channels are eight optical emission channels. By reasonably arranging each optical port, a reasonable layout of the eight optical reception channels and the eight optical emission channels can be achieved to avoid mutual interference between the channels.

In the present disclosure, optical reception signals and optical emission signals are transmitted simultaneously through the optical waveguide substrate 900a. Since the optical elements of the optical reception component and optical elements of the optical emission component are in different space layers, if the optical reception signals and the optical emission signals are transmitted through an optical fiber ribbon, fiber winding or fiber coiling will occur, which would cause optical power loss, thereby reducing optical power. In view of this, the present disclosure can avoid fiber winding or fiber coiling with the optical waveguide substrate 900a, thereby reducing optical power loss.

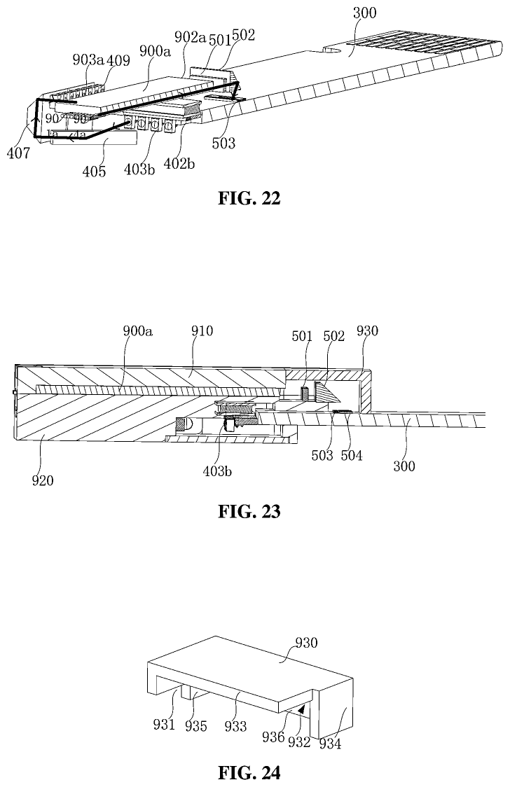

FIG. 22 is a schematic diagram of an optical path for transmitting an optical signal through an optical waveguide substrate according to some embodiments of the present disclosure. As shown in FIG. 22, in some embodiments, the optical reception component includes a second lens 501, a turning prism 502 and an optical reception chip 503. By way of example, the optical reception signal from the internal optical fiber enters the optical waveguide substrate 900a via the first input optical port 901a, and then is transmitted through the optical channel in the optical waveguide substrate 900a and output from the first output optical port 902a. The second lens 501 is disposed at the first output optical port 902a to receive the optical reception signal output from the first output optical port 902a.

In some embodiments, the optical emission component includes a laser chip 402, a reflector 405, etc. The optical reception chip 503 is disposed on the front surface of the circuit board 300, while the laser chip 402 is not disposed on a surface of the circuit board 300, but is disposed on a surface of the partition part 923. Exemplarily, the laser chip 402 is disposed in the lower space 925, and the optical emission signal emitted by the laser chip 402 is reflected by the reflector 405 into the displacement prism 407. The displacement prism 407 turns and guides the transmission direction of the optical emission signal output by the reflector 405 toward the second input optical port 903a of the optical waveguide substrate 900a, such that the optical emission signal is transmitted to the optical waveguide substrate 900a. Exemplarily, the light output side of the displacement prism 407 is located at the second input optical port 903a, and the optical emission signal output from the displacement prism 407 enters the optical waveguide substrate 900a via the second input optical port 903a, and then is transmitted to the second output optical port 904a through the optical channel in the optical waveguide substrate 900a. The optical emission signal is output from the second output optical port 904a, enters the internal optical fiber, and then is transmitted outside of the optical module through the external optical fiber coupled to the internal optical fiber.

FIG. 23 is a sectional view illustrating an internal structure of an optical module provided according to some embodiments of the present disclosure. As shown in FIG. 23, the opening 927 is formed at one end of the partition part 923, and one end of the circuit board 300 is inserted into the partition part 923 via the opening 927. A length of a surface of the upper space 924 is relatively greater than a length of the cover shell 910 such that the surface of the upper space 924 is exposed relative to the cover shell 910. The second lens 501 and the turning prism 502 are respectively arranged on the exposed surface, and the optical reception chip 503 and the TIA 504 are arranged on a surface of the circuit board 300. For example, the optical reception chip 503 and the TIA 504 are arranged on the front surface of the circuit board 300. The second lens 501 and the turning prism 502 are arranged toward the front surface of the circuit board 300, and the light exiting surface of the turning prism 502 is toward the front surface of the circuit board 300. For example, the light exiting surface of the turning prism 502 is toward the optical reception chip 503 arranged on the front surface of the circuit board 300.

The lower space 925 is configured to respectively arrange the laser chip 402 and the reflector 405. One end of the circuit board 300 is inserted into the partition part 923 through the opening 927. For example, the circuit board 300 is inserted to one side of the laser chip 402, the laser chip 402 is electrically connected to the other surface of the circuit board 300 by wire bonding. For example, the laser chip 402 is connected to the back surface of the circuit board 300 through wire bonding. At the same time, in order to ensure the transmission performance of high-frequency signals, the other surface of the circuit board 300 is flush with the surface of the laser chip 402. For example, the back surface of the circuit board 300 is flush with the surface of the laser chip 402, which is conducive to shortening the wire bonding length between the circuit board 300 and the laser chip 402, thereby ensuring the transmission performance of high-frequency signals.

The circuit board 300 extends into the partition part 923 through the opening 927. At this time, one surface of the circuit board 300, such as the front surface, is configured to arrange the optical reception chip 503 and the TIA 504, and the other surface of the circuit board 300, such as the back surface, is flush with the surface of the laser chip 402, and the back surface of the circuit board 300 is connected to the laser chip 402 by wire bonding.

The second lens 501 is located on the side of the first output optical port 902a of the optical waveguide substrate 900a to receive the optical reception signal output from the optical waveguide substrate 900a; the light exiting surface of the second lens 501 faces the turning prism 502; the turning prism 502 is configured to reflect the optical signal toward the optical reception chip 503, so as to transmit the optical reception signal to the optical reception chip 503. Exemplarily, the light exiting surface of the turning prism 502 faces the front surface of the circuit board 300, for example, the light exiting surface of the turning prism 502 faces the optical reception chip 503; the optical reception chip 503 is configured to convert the optical reception signal into an electrical signal, and transmit the electrical signal to the TIA 504, and the TIA 504 is configured to convert the electrical signal into a voltage signal, and amplify the voltage signal.

In some embodiments, when packaging the optical waveguide substrate 900a, the optical reception chip 503, the laser chip 402, etc., the optical waveguide substrate 900a needs to be fixed, for example, by the cover shell 910. Therefore, after the optical waveguide substrate 900a is installed, the cover shell 910 is to be installed to fix the optical waveguide substrate 900a; then optical elements, such as the laser chip 402, of the optical emission component are packaged to ensure the optical transmission power; and then optical elements, such as the optical reception chip 503, of the optical reception component are packaged. In order to facilitate the packaging of the optical reception chip 503 and other optical elements of the optical reception component, the length of the cover shell 910 is relatively smaller than the length of the surface of the upper space 924, so as to leave a certain space on the top surface of the base 920 for arranging the optical elements of the optical reception component, such as the optical reception chip 503. Exemplarily, the optical elements of the optical reception component, such as the optical reception chip 503, are packaged on the surface of the base 920 exposed relative to the cover shell 910. Therefore, the optical elements of the optical reception component, such as the optical reception chip 503, are exposed relative to the cover shell 910 to facilitate assembling the optical elements of the optical reception component, such as the optical reception chip 503.

Since the optical elements of the optical reception component, such as the optical reception chip 503, are exposed relative to the cover shell 910, a protective cover 930 is provided to protect the optical reception chip 503 and the like. Exemplarily, the protective cover 930 covers above the optical reception chip 503. In some embodiments, the protective cover 930 covers above the optical reception chip 503. In some embodiments, the protective cover 930 covers above the second lens 501, the turning prism 502, the optical reception chip 503 and the TIA 504. At this time, one end of the protective cover 930 is connected to the cover shell 910, and a bottom end of the protective cover 930 is arranged on the front surface of the circuit board 300. By way of example, a side wall of the protective cover 930 where the bottom end is located abuts on the front surface of the circuit board 300, thereby covering above the second lens 501, the turning prism 502, the optical reception chip 503 and the TIA 504.

FIG. 24 is a structural schematic diagram of a protective cover provided according to some embodiments of the present disclosure. As shown in FIG. 24, the protective cover 930 includes a cover plate 933 and side plates 934, 935 and 936 connected to the cover plate 933. The cover plate 933 is configured to cover the optical reception component, the side plate 934 and the side plate 935 are configured to be connected to the base 920, and the side plate 936 is configured to be connected to the circuit board 300. One side of the protective cover 930 is connected to the cover shell 910.

The protective cover 930 is formed, respectively on surfaces thereof, with a first notch 931 and a second notch 932. The first notch 931 is configured to be engaged with the base 920; the second notch 932 is configured to avoid or make way for the fourth side wall 922. The first notch 931 is abutted on and connected to the surface of the base 920, and the second notch 932 is matched with and connected to the fourth side wall 922, so as to achieve fixation of the protective cover 930. In some embodiments, the first notch 931 may abut on the surface of the partition part 923, and the second notch 932 may match with and connect with the fourth side wall 922.

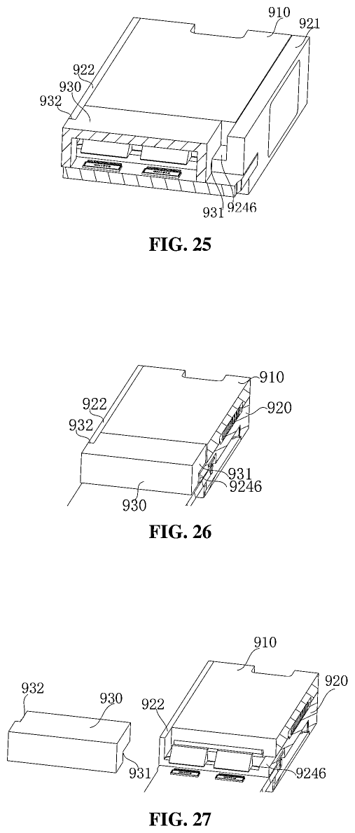

FIG. 25 is a first schematic sectional diagram of a protective cover provided according to some embodiments of the present disclosure in an assembled state; FIG. 26 is a second schematic sectional diagram of a protective cover provided according to some embodiments of the present disclosure in an assembled state; and FIG. 27 is a schematic diagram of a protective cover provided according to some embodiments of the present disclosure in a disassembled state. As shown in FIG. 25 to FIG. 27, in some embodiments, in order to facilitate assembling the protective cover 930 and to facilitate the removing and disassembling of the protective cover 930 when it needs to be repaired, there is a gap between a side wall of the protective cover 930 and the third side wall 921. The existence of the gap leaves an operating space for clamping the protective cover 930, thereby facilitating the removal and placement of the protective cover. For example, the protective cover 930 may be griped through the gap and an outward side of the second notch 932, such that the protective cover 930 is removed to be repaired.

The first notch 931 is connected with a surface of the partition part 923. Exemplarily, the first notch 931 is connected with a surface of the third support portion 9246, and the first notch 931 abuts on the surface of the third support portion 9246. The second notch 932 is connected with the fourth side wall 922. Exemplarily, the second notch 932 is matched and connected with the fourth side wall 922. One side of the protective cover 930 is connected with one side wall of the cover shell 910, and the bottom portion of the protective cover 930 is arranged on the surface of the circuit board 300 such that the protective cover 930 is supported by the circuit board 300. Thus, the protective cover 930 is respectively connected to the cover shell 910, the base 920 and the circuit board 300, such that the protective cover 930 is fixedly connected, and thus to protect the second lens 501, the turning prism 502, the optical reception chip 503 and the TIA 504 through the protective cover 930.

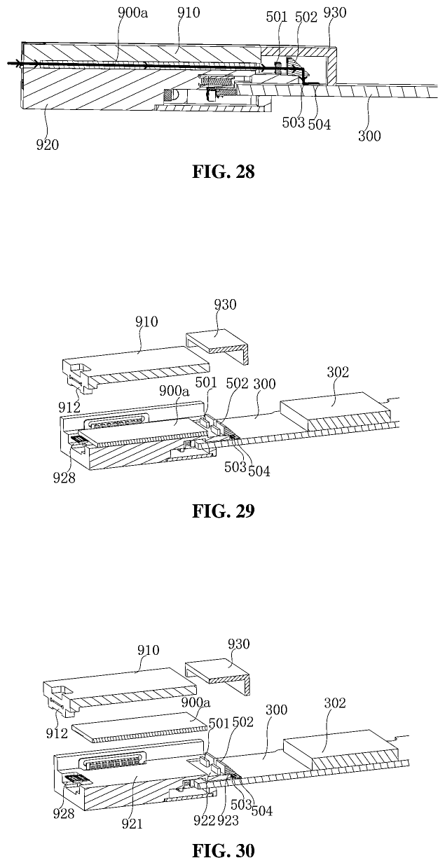

FIG. 28 is a schematic diagram showing a transmission optical path of an optical reception component provided according to some embodiments of the present disclosure; FIG. 29 is a first schematic diagram showing relative position relationships among a circuit board, an optical emission component and an optical reception component provided according to some embodiments of the present disclosure; and FIG. 30 is a second schematic diagram showing the relative position relationships among a circuit board, an optical emission component and an optical reception component provided according to some embodiments of the present disclosure. As shown in FIG. 28 to FIG. 30, the optical waveguide substrate 900a is disposed between the cover shell 910 and the base 920. Exemplarily, the optical waveguide substrate 900a is disposed between the cover shell 910 and the upper space 924. The upper space 924 is also configured to arrange the second lens 501 and the turning prism 502. The lower space 925 is configured to arrange optical elements such as the laser chip 402. It can be seen that the optical waveguide substrate 900a, the second lens 501 and the turning prism 502 are on the same layer, while the optical waveguide substrate 900a and the laser chip 402 are on different layers. Therefore, the optical reception signal output from the optical waveguide substrate 900a may be transmitted to the optical reception chip 503 after one reflection, while the optical emission signal generated by the laser chip 402 needs to be guided through a guiding optical path to guide the generated optical emission signal to the optical waveguide substrate 900a.

The optical reception signal output from the optical waveguide substrate 900a is transmitted to the second lens 501. The turning prism 502 is configured to reflect the optical reception signal downward to turn the transmission direction of the optical reception signal to the optical reception chip 503. For instance, the second lens 501 and the turning prism 502 are located at the first output optical port 902a to receive the optical reception signal output from the first output optical port 902a.

In some embodiments, the optical port of the optical waveguide substrate 900a is optically coupled to the internal optical fiber to transmit the optical reception signal and the optical emission signal. The extension plate 912 of the cover shell 910 is embedded in the support groove 928 of the base 920, thereby connecting the cover shell 910 and the base 920. The cover shell 910 has an accommodation cavity to accommodate and fix the optical waveguide substrate 900a.

In some embodiments, the top surface of the base 920 is respectively formed with the first surface 9241, the fourth surface 9242 and the third surface 9243. Wherein the first surface 9241 is configured to dispose the optical waveguide substrate 900a, and the fourth surface 9242 and the third surface 9243 are respectively configured to arrange the second lens 501 and the turning prism 502. The length of the top surface of the base 920 is relatively greater than the length of the cover shell 910, and the second lens 501 and the turning prism 502 are disposed on the portion of the top surface that is extra relative to the cover shell. At this time, the second lens 501 and the turning prism 502 are exposed relative to the cover shell 910, which is convenient for mounting the second lens 501 and the turning prism 502.

Optical axes of the second lens 501 and the turning prism 502 are on the same axis, the turning prism 502 is arranged along the output optical path of the second lens 501, the optical reception chip 503 is located below the turning prism 502, and the TIA 504 is located at one side of the optical reception chip 503. In an example, the second lens 501 is a converging lens, the turning prism 502 is configured to reflect the optical reception signal transmitted from the second lens 501 and reflect it to the optical reception chip 503, the optical reception chip 503 is configured to convert the received optical reception signal into a photocurrent signal and transmit the same to the TIA 504, and the TIA 504 is configured to convert the photocurrent signal into a voltage signal and amplify the voltage signal. When the optical module is multi-channel optical module, the second lens 501 may be arranged in an array, and accordingly, the turning prism 502, the optical reception chip 503 and the TIA 504 are all arranged in the form of an array.

The second lens 501 is located on the fourth surface 9242, and a light incident surface of the second lens 501 faces the optical waveguide substrate 900a. Exemplarily, the light incident surface of the second lens 501 faces the first output optical port 902a of the optical waveguide substrate 900a to receive the optical reception signal output from the first output optical port 902a; the light exiting surface of the second lens 501 faces the turning prism 502 to transmit the optical reception signal from the second lens 501 into the turning prism 502.

The turning prism 502 is located on the third surface 9243, the light incident surface of the turning prism 502 faces the second lens 501, while the light exiting surface thereof faces the optical reception chip 503 disposed on the front surface of the circuit board 300, and the turning prism 502 is configured to reflect the received optical reception signal toward the optical reception chip 503 disposed on the front of the circuit board 300. Exemplarily, the turning prism 502 has an inclined surface, through which the optical reception signal incident on its surface can be reflected, and an inclination angle of the inclined surface can be a preset inclination angle, so as to achieve a total reflection effect, and the optical signal incident on its surface is totally reflected. Exemplarily, the light incident surface of the turning prism 502 faces the second lens 501 to receive the optical signal transmitted through the second lens 501 and reflect the optical signal, thereby turning its optical path. For instance, the transmission optical path of the optical signal is turned downward to reflect the optical signal into the optical reception chip 503 located below the turning prism 502. The light exiting surface of the turning prism 502 faces the optical reception chip 503 to transmit the reflected optical signal to the optical reception chip 503.

The optical reception chip 503 is located on a surface of the circuit board 300. Exemplarily, the optical reception chip 503 is located on the front surface of the circuit board 300. The optical reception chip 503 is connected to the TIA 504 through wire bonding. The light incident surface of the optical reception chip 503 faces the light exiting surface of the turning prism 502 to receive the optical reception signal reflected by the turning prism 502. The TIA 504 is located on a surface of the circuit board 300. In an example, the TIA 504 is located on the front surface of the circuit board 300 and at one side of the optical reception chip 503. The TIA 504 is connected to the circuit board 300 by wire bonding.

In some embodiments, the optical reception signal, after entering the optical module, is transmitted along the internal optical fiber, enters the optical waveguide substrate 900a via the first input optical port 901a of the optical waveguide substrate 900a, is transmitted along the internal optical channels and then is output from the first output optical port 902a; the optical reception signal is further transmitted to the second lens 501, and, after being converged by the second lens 501, is transmitted to the turning prism 502. After being reflected by the inclined surface of the turning prism 502, the optical path turns downward and turns to the optical reception chip 503 on the circuit board 300. The optical reception chip 503 converts the received optical reception signal into a photocurrent signal, and then the TIA 504 converts the photocurrent signal into a voltage signal and amplifies the voltage signal.

The second lens 501 is located on the fourth surface 9242, and the optical reception chip 503 is located on the surface of the circuit board 300. A height of the fourth surface 9242 is relatively higher than a height of the circuit board 300, and there is a height difference between the second lens 501 and the optical reception chip 503. Therefore, the turning prism 502 is arranged along the output optical path of the second lens 501, such that the optical path of the optical signal transmitted out of the second lens 501 is turned downward by the turning prism 502 to the surface of the optical reception chip 503.

The second lens 501 and the turning prism 502 are arranged corresponding to each other such that the optical signal transmitted from the second lens 501 is incident on the turning prism 502. A focal length of the second lens 501 should be sufficient to ensure that the optical signal transmitted from the second lens 501 is reflected by the turning prism 502 and then focused on the surface of the optical reception chip 503, thereby reducing a size of the light spot and making the optical reception signal fall within the signal reception range of the optical reception chip 503.

In some embodiments, the first surface 9241 where the optical waveguide substrate 900a is located, the fourth surface 9242 where the second lens 501 is located, and the third surface 9243 where the turning prism 502 is located are designed in a stepped manner, such that optical axes of the optical waveguide substrate 900a, the second lens 501 and the turning prism 502 are on the same axis.

In some embodiments, one end of the circuit board 300 is inserted into the opening 927, and the optical reception chip 503 and the TIA 504a are arranged on a surface of the circuit board 300 that is exposed relative to the cover shell 910. The optical signal output from the turning prism 502 is transmitted to the surface of the optical reception chip 503, the optical signal is then converted, processed or the like.

Exemplarily, a portion of the turning prism 502 is arranged on the third surface 9243, and another portion is not on the third surface 9243, but is suspended relative to the third surface 9243. The optical reception chip 503 is located under the suspended portion, such that the optical signal, after being reflected by the turning prism 502, passes through the light exiting surface of the suspended portion and is transmitted to the optical reception chip 503.

For example, a thickness of the optical waveguide substrate 900a is smaller than a height of the second lens 501, and thus the first surface 9241, on which the optical waveguide substrate 900 a is located, is at a higher level than the fourth surface 9242 on which the second lens 501 is located.

In the present disclosure, the optical reception chip 503 and the optical waveguide substrate 900a are on the same layer, and the transmission of the optical reception signal is on the same layer, therefore, there is no need to switch and guide the optical path in terms of height. The transmission path of the optical reception signal is relatively simple, and there are fewer optical devices along the transmission path, which reduces the optical power loss and allows more optical reception signals to be transmitted to the surface of the optical reception chip 503.

In some embodiments of the present disclosure, as the rate of the optical module is increased, the photosensitive surface of the optical reception chip 503 becomes smaller and smaller. For example, the photosensitive surface is reduced from 30 μm to 16 μm, or even to 12 um. However, the smaller photosensitive surface affects the optical coupling efficiency. The second lens 501 focuses the received optical reception signal once, and in order to improve the optical coupling efficiency, a second focusing may be performed before the optical reception signal is transmitted to the surface of the optical reception chip 503 so as to improve the optical coupling efficiency and increase the coupling tolerance.

In some embodiments, a spherical lens may be arranged between the turning prism 502 and the optical reception chip 503. The second lens 501 focuses the received optical signal once, and the spherical lens focuses the optical signal output by the turning prism 502 for a second time, which can improve the light coupling efficiency. However, a light spot output by the spherical lens is mostly a light spot with uneven energy distribution, when the light spot with uneven energy distribution is coupled to the photosensitive surface, energy may be concentrated in a certain range of the photosensitive surface, causing the photocurrent overshoot phenomenon. Meanwhile, the focal length of the spherical lens is generally difficult to adjust, which may affect the light coupling efficiency. Further, consistency of the spherical center of the spherical lens is generally poor due to its manufacturing process, which may lead to poor consistency of the optical path and thus reduces the coupling efficiency.

In some embodiments, an aspheric lens, such as a metalens, may be arranged between the turning prism 502 and the optical reception chip 503. The second lens 501 focuses the received optical signal once, and the aspheric lens focuses the optical signal output by the turning prism 502 for a second time, thereby improving the light coupling efficiency. The aspheric lens has strong flexibility and freedom, and can output a uniform light spot, thereby avoiding the phenomenon of photocurrent overshoot. For example, the aspheric lens includes a substrate and several dielectric units arranged on the surface of the substrate. By changing the size or arrangement of the dielectric units, a light spot with uniform energy distribution can be output, thereby avoiding the phenomenon of photocurrent overshoot. Meanwhile, the focal length of the aspheric lens is easier to control. For example, the focal length of the aspheric lens may be adjusted by changing the size or arrangement of the dielectric units, thereby improving the light coupling efficiency. In addition, in the present disclosure, an aspheric lens may be monolithically integrated or wafer-integrated with the optical reception chip, thereby reducing a tolerance that may be introduced in the patch process, thereby improving the coupling efficiency.

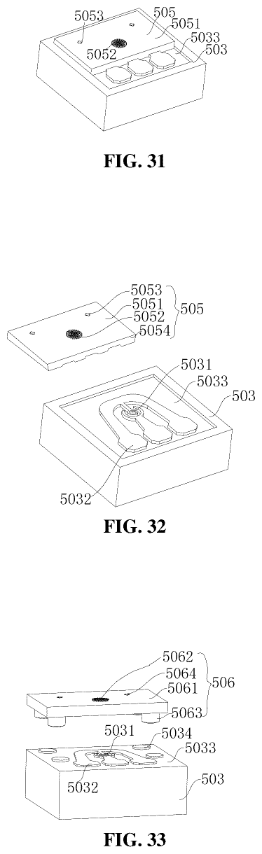

FIG. 31 is a structural diagram of an optical reception chip provided according to some embodiments of the present disclosure; FIG. 32 is a schematic exploded diagram of an optical reception chip provided according to some embodiments of the present disclosure. As shown in FIG. 31 and FIG. 32, in some embodiments, an aspheric lens 505 is provided on the surface of the optical reception chip 503. The second lens 501, the third lens 403 and the first lens 409 may be regarded as spherical lenses in comparison to the aspheric lens 505. The aspheric lens 505 and the photosensitive surface of the optical reception chip 503 are concentrically arranged. In this case, an optical reception signal is focused by the second lens 501 once and then enters the turning prism 502. The aspheric lens 505 focuses the optical reception signal reflected from the turning prism 502 for a second time. In this way, the size of the spot is reduced, and the spot is focused on a smaller photosensitive surface, and the light coupling efficiency is improved.

The aspheric lens 505 outputs a light spot with uniform energy distribution, which may avoid photocurrent overshoot. Meanwhile, the focal length of the aspheric lens 505 is easy to adjust, such that the light spot is focused on the photosensitive surface of the optical reception chip 503, thereby improving the light coupling efficiency.

In some embodiments, the optical reception chip 503 includes a top surface 5033. A photosensitive surface 5031 is disposed on the top surface 5033, and a G-S-G pad 5032 is arranged on the top surface surrounding the photosensitive surface 5031. The G-S-G pad 5032 is a ground-signal-ground pad. As channel transmission rate increases, the area of the photosensitive surface 5031 decreases, so the light spot of the optical reception signal coupled to the optical reception chip 503 should be reduced in size such that the light spot falls within the photosensitive surface 5031.

In some embodiments, the aspheric lens 505 may be mounted on the surface of the optical reception chip 503. When mounting the aspheric lens 505, it is necessary to identify the relative position of the aspheric lens 505 and the center of the photosensitive surface of the optical reception chip 503. The accuracy requirement is very high. The compatibility between the channels must also be considered during array coupling.

In some embodiments, the aspheric lens 505 is combined with the optical reception chip 503 through a MEMS process to achieve optical expansion of the photosensitive surface of the front-illuminated optical reception chip 503, thereby improving the light coupling efficiency. Exemplarily, the MEMS process includes the steps of photolithography, epitaxy, thin film deposition, oxidation, diffusion, injection, sputtering, evaporation, etching, scribing and packaging or the like.

In the present disclosure, the following factors are considered, on the one hand, the spherical lens cannot output a uniform light spot to the optical reception chip; on the other hand, the surface of the substrate 5051 faces the turning prism 502, therefore, if a spherical lens is provided on the surface of the substrate 5051, the light spot output by the spherical lens may be focused above the photosensitive surface, since the spherical lens achieves the focusing effect through refraction and the curved surface is relatively away from the photosensitive surface of the optical reception chip 503. In view of this, the present disclosure prefers to employ an aspherical lens between the turning prism 502 and the optical reception chip 503.

In some embodiments, an aspherical lens 505 may be obtained from non-spherical dielectric units etched on the surface of the substrate 5051. For example, if the aspherical lens 505 is a metalens, its focal length may be adjusted by adjusting size or arrangement of the dielectric units and other parameters such that the output light spot falls on the photosensitive surface. The metalens, also known as a metasurface lens, has a two-dimensional aspherical lens structure. The metalens focuses light through a metasurface, such as a planar two-dimensional metamaterial with sub-wavelength thickness. Compared with traditional lenses, the metalens has such advantages as thinner volume, lighter weight, lower cost, better imaging, and easier integration, and provides a potential solution for compact integrated optical systems, it can also adjust properties of light such as polarization, phase and amplitude by adjusting the shape, rotation direction, height and other parameters of the structure.

In some embodiments, the aspheric lens 505 is disposed on the surface of the optical reception chip 503 by a CMOS process. Exemplarily, a substrate 5051 is grown along the G-S-G pad 5032 on the top surface 5033 of the aspheric lens 505, and then several dielectric units 5052 are etched on an exposed surface of the substrate 5051, i.e., the top surface. Since the G-S-G pad 5032 has a certain thickness and the bottom surface of the substrate 5051 needs to be embedded in the surface of the G-S-G pad 5032, grooves are formed on the bottom surface 5054 of the substrate 5051, and each groove is just embedded on the surface of the G-S-G pad 5032. Besides, it is necessary to ensure that the top surface of the substrate 5051 is flat so as to facilitate etching to form the dielectric units 5052. Exemplarily, the center of the dielectric unit 5052 is concentric with the center of the photosensitive surface 5031 to improve the light coupling efficiency.

The substrate 5051 and the dielectric unit 5052 may be made of a light-transmitting material, such as SiO2 and the like. The material(s) of the substrate 5051 and the dielectric unit 5052 may be selected according to the wavelength of the optical reception signal, the transmittance, the CTE matching with the substrate material, etc.

In some embodiments, the dielectric unit may be in the form of a dielectric column, and several dielectric columns are arranged in an array. The array may be a rectangular array. Alternatively, the dielectric units may be arranged by taking the center of the substrate 5051 as a center of a circle and then performing etching outward in sequence, for example, a certain number of dielectric columns may be arranged in a circle, in this way, a dielectric column array in circles of different diameters may be obtained.

For instance, the dielectric column is a silicon column or a silicon oxide column. By adjusting the size of the dielectric column or the arrangement of each dielectric unit array, such as the arrangement interval, continuous phase adjustment is achieved. The initial phase of the incident light incident on different positions may be regulated, such that interference occurs between different incident lights, and thus energies of the incident lights are gradually concentrated in the same direction, thereby achieving a focusing effect.

In the present disclosure, by adjusting the size of the dielectric column or the arrangement of each dielectric unit array, such as the arrangement interval, the properties of the light spot, such as the energy distribution of the light spot, can be adjusted to output a light spot with uniform energy distribution, thereby avoiding the photocurrent overshoot phenomenon.

In the present disclosure, since the substrate is grown by thin film growth, it is preferred that the substrate is not grown to be too thick so as to avoid stress. In other words, it is preferred that the substrate 5051 has a thin size. In this case, it is required that the focal length of the lens on the substrate surface is relatively small, such that the light spot is focused on the photosensitive surface. In some embodiments, a spherical lens is disposed on the surface of the substrate, the focusing effect of the spherical lens may be affected by curvature radius and refractive index, and it may be difficult to make the spherical lens have a small focal length by adjusting the curvature radius or the refractive index, and in this case, the focal length of the spherical lens causes the light spot to be focused below the photosensitive surface, which would reduces the light coupling efficiency.

Since the substrate has a thin thickness, the corresponding focal length is small. If a spherical lens is employed, it is not easy to obtain such a small focal length even by adjusting the curvature radius and the refractive index to limits. If an aspherical lens is employed, the focal length can be adjusted by adjusting the size of the dielectric column or the arrangement of each dielectric unit array, such as the arrangement interval, such that the aspherical lens has a small focal length, so as to adapt to the thin substrate, and to focus the light spot on the photosensitive surface. For example, a preset focal length of the aspherical lens 505 can be obtained according to the thickness of the substrate, that is, there is a preset relationship between the preset focal length of the aspherical lens 505 and the thickness of the substrate. If the substrate is thin, the preset focal length of the preset lens is small. The preset focal length of the aspherical lens 505 can match the thickness of the substrate, and finally the light spot is focused on the surface of the optical reception chip 503.

In some embodiments, when mounting the optical reception chip 503, mounting alignment is performed through the center of the photosensitive surface. Since the photosensitive surface is covered by the aspheric lens 505 in the present disclosure, an identification position 5053 is formed on the surface of the aspheric lens 505. The optical reception chip 503 is mounted through the relative position relationship between the identification position 5053 and the center of the photosensitive surface 5031 to ensure the mounting accuracy.

In some embodiments, an aspheric lens 506 is mounted above the surface of the optical reception chip 503, with a certain distance between a substrate of the aspheric lens 506 and the surface of the optical reception chip 503. The aspheric lens 506 and the photosensitive surface of the optical reception chip 503 are concentrically arranged. In this case, the second lens 501 focuses the optical signal once, the optical signal then enters the turning prism 502. The aspheric lens 506 focuses the optical signal reflected from the turning prism 502 for a second time, thereby reducing the size of the light spot, such that the light spot is focused on a smaller photosensitive surface, and the light coupling efficiency is improved.

The aspheric lens 506 outputs a light spot with uniform energy distribution, which can avoid photocurrent overshoot. At the same time, it is easy to adjust the focal length of the aspheric lens 506 such that the light spot is focused on the photosensitive surface of the optical reception chip 503, which thus improves the light coupling efficiency.

In some embodiments, the aspheric lens 506 may be bonded to the surface of the optical reception chip 503 by optical adhesive. In some embodiments, the aspheric lens 506 may be combined with the optical reception chip 503 by MEMS technology.

FIG. 33 is an exploded schematic diagram of another optical reception chip according to some embodiments of the present disclosure. As shown in FIG. 33, in some embodiments, the aspheric lens 506 is a metalens. In the case that the aspheric lens 506 is a metalens, and the metalens is combined with the optical reception chip 503 by the CMOS process, a connecting pad 5034 is further disposed on the surface of the optical reception chip 503, in addition to the photosensitive surface 5031 and the GSG pad 5032. Exemplarily, the connecting pad 5034 is configured to connect the optical reception chip 503 and the metalens.

In some embodiments, in the case that the aspheric lens 506 is a metalens, the aspheric lens 506 includes a substrate 5061, a dielectric unit 5062 formed by etching the top surface of the substrate 5061, and a protrusion 5063 formed by electroplating the bottom surface of the substrate 5061. Exemplarily, the substrate 5061 is a silicon-based wafer, and the dielectric unit 5062 is formed by etching on the surface of the silicon-based wafer; exemplarily, the protrusion 5063 is in the form of a convex column, and the convex column may be a metal column, such as a copper column. The protrusion 5063 is connected to the connecting pad 5034 by metal solder, thereby realizing connection between the optical reception chip 503 and the metalens.

Similarly, the dielectric unit is in a form of a dielectric column, and several dielectric columns are arranged in an array, which may be a rectangular array. Alternatively, the dielectric units may be arranged by taking the center of the substrate 5051 as a center of a circle and performing the etching outwards in sequence, for example, a number of dielectric columns may be arranged in a circle, and then a dielectric column array including circles of different diameters may be obtained.

By way of example, the dielectric column is a silicon column or a silicon oxide column. By adjusting the size of the dielectric column or the arrangement of each dielectric unit array, such as the arrangement interval, the properties of the light spot, such as the light spot energy distribution, can be adjusted to output a light spot with uniform energy distribution, thereby avoiding the photocurrent overshoot phenomenon.

In some embodiments, an aspheric lens, such as a metalens, is disposed on the surface of the substrate. The focal length can be adjusted by adjusting a size of the dielectric column or arrangement of the dielectric unit array, such as the arrangement spacing, such that the aspheric lens has a small focal length to adapt to a thin substrate, thereby focusing the light spot on the photosensitive surface.

Since there is a protrusion 5063 between the substrate 5061 and the photosensitive surface of the optical reception chip 503, upper and lower surfaces of the substrate 5061 may be etched to form the dielectric units.

The protrusion 5063 has a preset height to match the focal length of the aspheric lens 506 such that the output light spot is focused on the photosensitive surface of the optical reception chip 503.

In some embodiments, an identification position 5064 is formed on the surface of the aspheric lens 506. The optical reception chip 503 is mounted based on a relative position relationship between the identification position 5064 and the center of the photosensitive surface 5031 to ensure mounting accuracy.

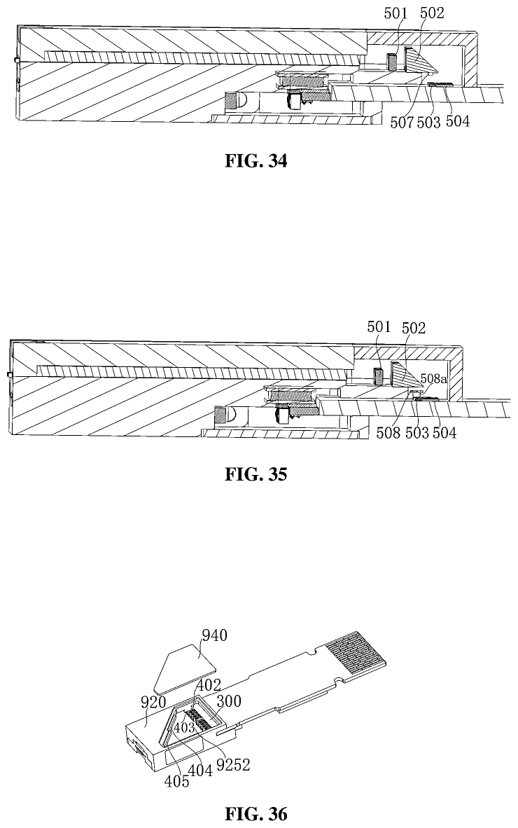

FIG. 34 is sectional diagram showing an internal structure of another optical module provided according to some embodiments of the present disclosure. As shown in FIG. 34, in some embodiments, an aspheric lens 507 is provided on the light exiting surface of the turning prism 502, and the aspheric lens 507 is attached to the light exiting surface of the turning prism 502 by optical adhesive.

An optical signal output from the turning prism 502 is converged by the aspheric lens 507 and then incident on the surface of the optical reception chip 503, thereby further reducing a size of the light spot of the optical signal through secondary focusing, such that the spot falls on the photosensitive surface of the optical reception chip 503, which thus improves the optical coupling efficiency.

In some embodiments, the aspheric lens 507 also includes a substrate, and dielectric units are etched on a surface of the substrate. The focal length is adjusted by changing the size or arrangement of the dielectric units so that the light spot is focused on the photosensitive surface, and the output light spot is a light spot with uniform energy distribution.

In some embodiments, the substrate of the aspheric lens 507 is connected to the light exiting surface of the turning prism 502, and dielectric units are formed by etching on a surface of the substrate that faces the optical reception chip.

In some embodiments of the present disclosure, the light exiting surface of the turning prism 502 is used as a substrate, and dielectric units are formed thereon. Since the light exiting surface of the turning prism 502 is made of glass, it is difficult to form the dielectric unit through an etching process. Exemplarily, the dielectric unit can be formed by melt injection molding.

FIG. 35 is a sectional view of an internal structure of another optical module provided according to some embodiments of the present disclosure. As shown in FIG. 35, a support portion 508a is provided on the surface of the circuit board 300, and an aspheric lens 508 is provided on a surface of the support portion 508a. The aspheric lens 508 is arranged between the turning prism 502 and the optical reception chip 503. The aspheric lens 508 performs secondary focusing on the optical signal reflected from the turning prism 502 to reduce the size of the light spot of the optical signal, such that the spot falls on the photosensitive surface of the optical reception chip 503, thereby improving the light coupling efficiency.

In some embodiments, the aspheric lens 508 also includes a substrate, and the dielectric units are formed by etching the surface of the substrate. The substrate of the aspheric lens 508 is manufactured by the same process as the substrate of the aspheric lens 506, and the dielectric unit of the aspheric lens 508 is manufactured by the same process as the dielectric unit of the aspheric lens 506. The substrate of the aspheric lens 508 is a silicon-based wafer, and the dielectric units are formed by etching the surface of the silicon-based wafer. The dielectric unit of the aspheric lens 508 is also a metalens, and by adjusting initial phases of incident lights that are incident on different positions such that interference occurs between different incident lights, and energy's of the incident lights are gradually concentrated in the same direction, a focusing effect is achieved.

In the present disclosure, the optical reception chip 503 and the optical waveguide substrate 900a are in the same layer, the optical reception signal is transmitted in the same layer, and the transmission optical path of the optical reception signal is simple; the laser chip 402 and the optical waveguide substrate 900a are in different layers, the optical emission signal is transmitted in different layers, and thus the transmission optical path of the optical emission signal is relatively complex. When active coupling is performed, optical power loss borne by an optical emission end is generally higher than that of an optical reception end, since the optical emission end has its own light source. Thus the optical reception end may have a simpler optical path than the optical emission end. In other words, it is more suitable for the optical emission end to have a complex optical path than the optical reception end. For this reason, in the present disclosure, a same-layer transmission is set between the transmission of the optical reception signal and the optical waveguide substrate 900a, and a cross-layer transmission is set between the transmission of the optical emission signal and the optical waveguide substrate 900a.

In some embodiments, the back surface of the circuit board 300 faces in the same direction as the bottom surface of the base 920. As is known from the above, the back surface of the circuit board 300 refers to a surface of the circuit board opposite to that where the DSP chip 302 is disposed.

The bottom surface of the base 920 is also disposed with a lid 940, which is covered on the bottom surface of the base 920 to protect the optical emission component.

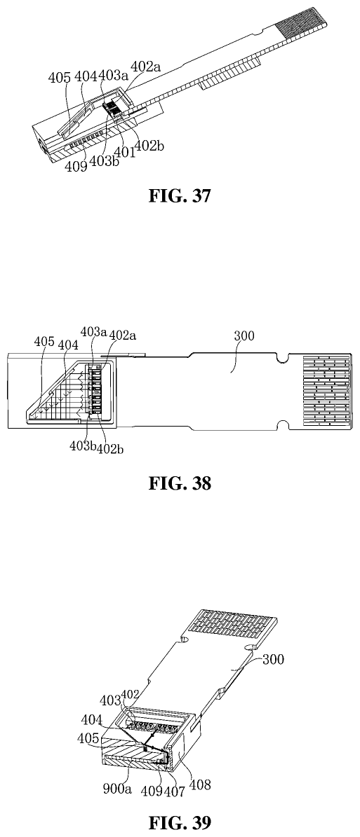

FIG. 36 is a structural diagram of an optical emission component provided according to some embodiments of the present disclosure, and FIG. 37 is a sectional diagram of an optical emission component provided according to some embodiments of the present disclosure. As shown in FIG. 36 and FIG. 37, after the lid 940 is removed from the bottom surface of the base 920, it can be seen that the bottom surface of the base 920 is recessed towards the upper space 924 to form the lower space 925. The lower space 925 includes the first recessed portion 9251 and the second recessed portion 9252 with different recessed degrees (see FIG. 16). Optical elements of the optical emission end are respectively arranged in the lower space 925, such as a TEC 401, a laser chip 402, a third lens 403, a reflector, etc. The light emitted by the laser chip 402 is divergent light; the third lens 403 is a collimating lens, which is configured to collimate the divergent light emitted by the laser chip 402 into parallel light; the first lens 409 is a converging lens. In a case that the optical module is a multi-channel optical module, the laser chip 402, the third lens 403, the first lens 409, etc. are arranged in the form of an array. The laser chip 402 and the third lens 403 are both arranged on a surface of the TEC 401, and the third lens 403 is arranged in an optical path of the laser chip 402. The TEC 401 is configured to ensure that the laser chip 402 is within a certain working range so as to ensure the stability of the output optical power of the laser chip 402.

The TEC 401, the laser chip 402 and third lens 403 constitute a light-emitting assembly, which is arranged in the first recessed portion 9251. Since the laser chip 402 is located in the lower space 925, while the optical waveguide substrate 900a is located in the upper space 924, it is necessary to guide the optical path so as to guide the optical emission signal generated by the laser chip 402 to the optical waveguide substrate 900a, and to transmit the optical emission signal through the optical waveguide substrate 900a. To this end, a reflector is arranged in the output optical path of the laser chip 402. The reflector is configured to guide the optical emission signal towards a side wall of the base 920, for example, towards a side wall of the partition part 923. Then, a displacement prism is arranged on the side wall of the base 920, for example, on the side wall of the partition part 923. The reflector reflects the optical emission signal towards the displacement prism, and the displacement prism guides the optical emission signal into the optical waveguide substrate 900a, for example, guides the optical emission signal into the second input optical port 903a such that the optical emission signal transmitted into the optical waveguide substrate 900a through the second input optical port 903a, and is transmitted through the optical waveguide substrate 900a.

In some embodiments, a side of the second recessed portion 9252 is connected with a vertical surface, and the reflector is arranged on the vertical surface, thereby fixing the reflector. Since the TEC 401 of the light-emitting assembly has a certain height, the first recessed portion 9251 is more recessed relative to the second recessed portion 9252 so as to ensure that the collimated light transmitted from the third lens 403 is incident on the reflector.

In some embodiments, both a light input end and a light output end of the displacement prism are exposed relative to the partition part 923. In particular, the light input end of the displacement prism faces the lower space 925, while the light output end of the displacement prism faces the upper space 924. With the displacement prism, the optical emission signal generated by the laser chip 402 is guided to the second input optical port 903a located in the upper space 924, and then is transmitted to the optical waveguide substrate 900a.

In some embodiments, in a case that the optical module is an 800G optical module, it includes eight laser chips 402, and the eight laser chips 402 are divided into two groups, namely a first laser chip array 402a and a second laser chip array 402b. Each of the first laser chip array 402a and the second laser chip array 402b includes four laser chips 402. In order to monitor the working temperature of the laser chip 402, a thermistor is provided between the first laser chip array 402a and the second laser chip array 402b, that is, a thermistor is provided between two adjacent laser chips of the first laser chip array 402a and the second laser chip array 402b. Four laser chips 402 of the first laser chip array 402a are equally spaced, and four laser chips 402 of the second laser chip array 402b are equally spaced. However, the presence of the thermistor increases a distance between a last laser chip 402 of the first laser chip array 402a and a first laser chip 402 of the second laser chip array 402b, that is, the distance between two adjacent laser chips in the first laser chip array 402a and the second laser chip array 402b increases. To this end, as an example, the reflector includes a first reflector 404 and a second reflector 405, and the first reflector 404 and the second reflector 405 are arranged offset to compensate for the optical channel spacing difference caused by the presence of the thermistor.

Correspondingly, when the number of laser chips 402 is eight, the number of the third lenses 403 is eight, and the eight third lenses 403 are divided into two groups, namely a first lens array 403a and a second lens array 403b. The first lens array 403a is arranged in the output optical path of the first laser chip array 402a, and the two correspond one to one; the second lens array 403b is arranged in the output optical path of the second laser chip array 402b, and the two correspond one to one.

A light incident surface of the first lens array 403a is arranged corresponding to a light exiting surface of the first laser chip array 402a, and a light exiting surface of the first lens array is arranged corresponding to the first reflector 404, such that an optical emission signal emitted by the first laser chip array 402a is incident on a surface of the first reflector 404 after passing through the first lens array 403a, and reflected and transmitted by the first reflector 404.

A light incident surface of the second lens array 403b is arranged corresponding to a light exiting surface of the second laser chip array 402b, and a light exiting surface of the second lens array is arranged corresponding to the second reflector 405, such that an optical emission signal emitted by the second laser chip array 402b is incident on a surface of the second reflector 405 after passing through the second lens array 403b, and is reflected and transmitted by the second reflector 405.

Referring to FIG. 16, in order to arrange the first reflector 404 and the second reflector 405, a first vertical surface 9253 and a second vertical surface 9254 are respectively connected to one side of the second recessed portion 9252. The first vertical surface 9253 and the second vertical surface 9254 are perpendicular to the surface of the second recessed portion 9252. The first vertical surface 9253 is configured so as to arrange the first reflector 404, and the second vertical surface 9254 is configured so as to arrange the second reflector 405. Exemplarily, the first reflector 404 is attached to a surface of the first vertical surface 9253, and the second reflector 405 is attached to a surface of the second vertical surface 9254, so as to achieve fixations of the first reflector 404 and the second reflector 405.

FIG. 38 is a partial structural diagram of an optical emission component provided according to some embodiments of the present disclosure. As shown in FIG. 38, the divergent light output by the laser chip 402 is converted to collimated light after being collimated by the third lens 403, and the collimated light beam transmitted by the third lens 403 is incident on the surface of the corresponding first reflector 404 or the second reflector 405.

In some embodiments, the first reflector 404 is an elongate reflector, which receives an optical signal transmitted from the first lens array 403a with a large light receiving area; the second reflector 405 is also an elongate reflector, which receives an optical signal transmitted from the second lens array 403b with a large light receiving area.

In order to compensate for the optical channel spacing difference caused by the position of the thermistor, the first reflector 404 and the second reflector 405 are misaligned. Exemplarily, the first reflector 404 arranged to be farther away from the third lens 403 than the second reflector 405.

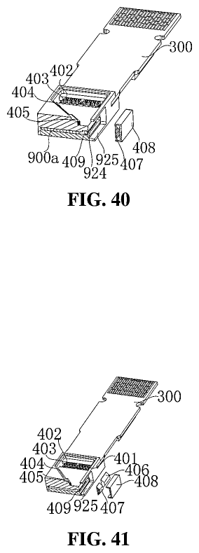

FIG. 39 shows an optical path of an optical emission component provided according to some embodiments of the present disclosure; FIG. 40 is a first side sectional view of an optical emission component provided according to some embodiments of the present disclosure; and FIG. 41 is a second side sectional view of an optical emission component provided according to some embodiments of the present disclosure. As shown in FIG. 39 to FIG. 41, the displacement prism is arranged on a side wall of a base 920. For example, the displacement prism is disposed on a side wall of the partition part 923. The light input end of the displacement prism faces the layer where the laser chip 402 is located, and the light output end thereof faces the light input end of the optical waveguide substrate 900a, for example, faces the second input optical port 903a, so as to guide an optical emission signal output by the reflector towards the second input optical port 903a.

In order to correspond to the first reflector 404 and the second reflector 405, the displacement prism includes a first displacement prism 406 and a second displacement prism 407. The first reflector 404 corresponds to the first displacement prism 406, and the second reflector 405 corresponds to the second displacement prism 407. A light exiting surface of the first reflector 404 faces A light incident surface of the first displacement prism 406, such that an optical signal output by the first reflector 404 is transmitted to surface of the first displacement prism 406; a light exiting surface of the second reflector 405 faces a light incident surface of the second displacement prism 407, such that an optical signal output by the second reflector 405 is transmitted to surface of the second displacement prism 407.

In some embodiments, the first displacement prism 406 and the second displacement prism 407 are both fixed on a fixing frame 408. The fixing frame 408 encloses the first displacement prism 406 and the second displacement prism 407, and then the fixing frame 408 is fixed in the hollowed portion 926 of the side wall of the base 920, thereby fixing the first displacement prism 406 and the second displacement prism 407.

In order to facilitate transmission of the optical path, sizes of the hollowed portion 926 is designed so as to expose the upper and lower surfaces of the partition part 923. The light input end of the displacement prism faces the lower surface of the partition part 923, and the light output end of the displacement prism faces the upper surface of the partition part 923. Thus, the light input end and the light output end of the displacement prism are both exposed relative to the partition part 923, which is beneficial to the transmission of optical emission signals along the upper and lower surfaces of the partition part. For example, optical emission signals that are transmitted to the first displacement prism 406 and the second displacement prism 407 are transmitted along the lower surface of the partition part, and optical emission signals output from the first displacement prism 406 and the second displacement prism 407 are transmitted along the upper surface of the partition part.

The first displacement prism 406 and the second displacement prism 407 are configured to turn transmission directions of optical emission signals generated by the first laser chip array 402a and the second laser chip array 402b towards the optical waveguide substrate 900a, respectively, such that the optical emission signals emitted by the optical emission component is transmitted outside of the optical module through the optical waveguide substrate 900a.

One end of the first displacement prism 406 faces the first reflector 404, and the other end thereof faces the optical waveguide substrate 900a. One end of the second displacement prism 407 faces the second reflector 405, and the other end thereof faces the optical waveguide substrate 900a, so as to respectively reflect optical signals reflected by the corresponding reflectors, such that the optical transmission signal is transmitted to the optical waveguide substrate 900a.

In some embodiments, the first displacement prism 406 is configured to receive optical signal output sequentially from the first laser chip array 402a, the first lens array 403a and the first reflector 404, and change the transmission direction of the optical signal, for example, to change the transmission path of the optical signal from being under the bottom surface of the base 920 to being above the top surface of the base 920 after two reflections. The second displacement prism 407 has similar function.

The first displacement prism 406 includes a straight surface, a first inclined surface and a second inclined surface. One end of the straight surface is connected to the first inclined surface, and the other end of the straight surface is connected to the second inclined surface. The straight surface acts both as a light incident surface and a light exiting surface and faces both the first reflector 404 and the optical waveguide substrate 900a. A portion of the straight surface that acts as the light incident surface faces the first reflector 404, and another portion of the straight surface that acts as the light exiting surface faces the optical waveguide substrate 900a. The first inclined surface and the second inclined surface are arranged opposite to each other, and the inclination trend of the first inclined surface is arranged opposite to the inclination trend of the second inclined surface. The first inclined surface is orientated towards the bottom surface of the base 920, for example, towards the first reflector 404; the second inclined surface is orientated towards the top surface of the base 920, for instance, towards where the first lens 409 and the optical waveguide substrate 900a are located. The second inclined surface faces the first lens 409, and the first lens 409 faces the second input optical port 903a of the optical waveguide substrate 900a, in such a way that an optical emission signal output by the laser chip 402 is turned to the second input optical port 903a of the optical waveguide substrate 900a, and is then transmitted to the second output optical port 904a along the optical channels in the optical waveguide substrate 900a, and is output along the second output optical port 904a, to the internal optical fiber, and then is transmitted to the outside of the optical module along the external optical fiber, thereby realizing emission of the optical emission signal. The second displacement prism 407 has similar working principle.

The first inclined surface of the first displacement prism 406 faces the first reflector 404, and is configured to receive an optical emission signal reflected by the first reflector 404, and reflect the optical emission signal reflected by the first reflector 404 towards the second inclined surface; the second inclined surface faces the direction where the first lens 409 and the optical waveguide substrate 900a are located, and is configured to receive an optical emission signal reflected from the first inclined surface, and reflect the optical emission signal reflected by the first inclined surface, such that the transmission direction of the optical emission signal is turned to the first lens 409, and then to the optical waveguide substrate 900a.

Both the first displacement prism 406 and the second displacement prism 407 are vertically arranged to extend beyond bottom surface and top surface of the base 920, such that the optical path turns to the top surface of the base 920, for example, to the optical waveguide substrate 900a on the top surface of the base 920, after being transmitted in the first displacement prism 406.

In some embodiments, an optical emission signal reflected from the first reflector 404 first reaches the first inclined surface of the first displacement prism 406, and then reaches the second inclined surface after being reflected by the first inclined surface. Then, after being reflected by the second inclined surface, the optical emission signal is output through the straight surface and reaches the first lens 409. The first lens 409 faces the second input optical port 903a of the optical waveguide substrate 900a. In this way, the optical emission signal generated by the laser chip 402 is turned to the second input optical port 903a of the optical waveguide substrate 900a, transmitted along the optical channels in the optical waveguide substrate 900a to the second output optical port 904a, and is output along the second output optical port 904a. Therefore, the first displacement prism 406 can perform two reflections such that the transmission direction of the optical signal is turned twice, in particular, the first reflection is made by the first inclined surface, through which the optical signal reflected from the first reflector 404 is reflected to the second inclined surface, and the transmission direction of the optical emission signal is turned from a direction along the output optical path of the first reflector 404 to the vertical direction, that is, to the second inclined surface; the second reflection is made by the second inclined surface, through which the optical emission signal reflected to the second inclined surface is reflected to the optical waveguide substrate, and the transmission direction of the optical emission signal is turned from the vertical direction to a direction toward the optical waveguide substrate 900a. Herein, the term “vertical direction” refers to a direction from the upper space 924 to the lower space 925.

In some embodiments, the first lens 409 is arranged in an array on the second surface 929, and the second surface 929 is located at a side of the second input optical port 903a of the optical waveguide substrate 900a, such that the optical signal transmitted by the first lens 409 enters the optical waveguide substrate 900a from the second input optical port 903a.

In some embodiments, the second surface 929 on which the first lens 409 is disposed is more recessed relative to the first surface 9241 on which the optical waveguide substrate 900a is disposed, such that the light output axis of the first lens 409 is in line with the light input axis of the optical waveguide substrate 900a.

In this disclosure, by arranging the displacement prism in the vertical direction, the first inclined surface of the displacement prism faces the bottom surface of the base 920, and the second inclined surface faces the top surface of the base 920. In this way, an optical path originally along the bottom surface of the base 920 can be turned twice such that the optical path is turned to be along the top surface of the base 920, for instance, to the optical waveguide substrate 900a arranged on the top surface of the base 920.

In the present disclosure, both the optical waveguide substrate 900a and the optical reception chip 503 are located in the upper space, i.e., on the top surface of the partition part 923, therefore the optical reception signal can be directly transmitted to the optical reception chip 503 along the optical channels inside the optical waveguide substrate 900a, thereby realizing the reception of the optical signal. Since the laser chip 402 is located in the lower space, i.e., on the bottom surface of the partition part 923, the optical emission signal generated by the laser chip 402 is guided by the reflector and the displacement prism, and the optical emission signal is guided to the second input optical port 903a of the optical waveguide substrate 900a, thereby realizing the emission of the optical signal.

The above only describes some specific embodiments of the present disclosure, and the protection scope of the present disclosure is not limited thereto. Any changes or substitutions that can be conceived by any person skilled in the art within the technical scope disclosed in the present disclosure should fall within the protection scope of the present disclosure. Therefore, the protection scope of this disclosure should be based on the protection scope of the claims.

1. An optical module, comprising:
a circuit board;
an optical waveguide substrate comprising: a first input optical port and a first output optical port arranged at opposite sides to transmit an optical reception signal; and a second input optical port and a second output optical port arranged at adjacent sides to transmit an optical emission signal, wherein the first input optical port and the second output optical port are at the same side, and the first output optical port and the second input optical port are at different sides;
a turning prism arranged at a side of the first output optical port and configured to receive and reflect the optical reception signal;
an optical reception chip disposed on a surface of the circuit board and configured to receive the optical reception signal reflected by the turning prism;
a laser chip electrically connected to the other surface of the circuit board, the laser chip and the optical waveguide substrate being located at different layers, and the laser chip being configured to generate an optical emission signal;
a reflector arranged in an output optical path of the laser chip and configured to reflect the optical emission signal; and
a displacement prism, wherein a light input end of the displacement prism faces the reflector, a light output end of the displacement prism faces the second input optical port, and the displacement prism is configured to guide the optical emission signal output from the reflector to the second input optical port so as to transmit the optical emission signal through the optical waveguide substrate.

2. The optical module according to claim 1, further comprising:
a cover shell, one end of the cover shell is formed with an optical fiber port, through which an inner optical fiber is inserted into the cover shell;
a base, one end of the base is formed with an opening, through which the circuit board is inserted in the base; and
wherein the optical waveguide substrate is arranged between the cover shell and the base such that the inner optical fiber is coupled with the optical waveguide substrate after entering into the cover shell through the optical fiber port; and
the displacement prism is arranged on a side wall of the base, with a light input end and a light output end of the displacement prism exposed relative to the base, and the reflector is configured to reflect the optical emission signal towards the side wall of the base.

3. The optical module according to claim 2, wherein the base comprises a partition part, an upper space located above the partition part and a lower space located below the partition part, and wherein
the optical waveguide substrate is located between the cover shell and the upper space; the turning prism is located in the upper space;
the laser chip and the reflector are located in the lower space; and
the displacement prism is located on a side wall of the partition part, and the light input end of the displacement prism faces the lower space, and a light output end of the displacement prism faces the upper space.

4. The optical module according to claim 3, wherein the cover shell comprise a first side wall and a second side wall that are arranged opposite to each other, and the base comprises a third side wall and a fourth side wall, and wherein a width between the third side wall and the fourth side wall is greater than a width between the first side wall and the second side wall such that the cover shell is disposed between the third side wall and the fourth side wall.

5. The optical module according to claim 4, wherein the third side wall is formed thereon with a hollowed portion, and the hollowed portion is configured such that an upper surface and a lower surface of the partition part are exposed, and the displacement prism is arranged in the hollowed portion.

6. The optical module according to claim 5, wherein the displacement prism is fixed in a fixing frame, and the fixing frame is embedded in the hollowed portion; and
the first side wall is formed thereon with an avoidance groove, and one side of the fixing frame is connected with a wall of the avoidance groove.

7. The optical module according to claim 4, wherein a boss is formed on one side of the first side wall, the boss being connected to a surface of the upper space; and the cover shell is formed, on a side of the cover shell facing the upper space, with an accommodation cavity to receive the optical waveguide substrate.

8. The optical module according to claim 3, wherein a first lens is arranged between the displacement prism and the second input optical port, the first lens being located in the upper space and configured to converge the optical emission signal output from the displacement prism into the optical waveguide substrate through the second input optical port.

9. The optical module according to claim 8, wherein the upper space comprises a first surface and a second surface, wherein the first surface is configured to carry the optical waveguide substrate, the second surface is configured to carry the first lens, and the first surface is located at a higher level than the second surface.

10. The optical module according to claim 8, wherein the upper space comprises a third surface and a fourth surface; and a second lens is arranged between the first output optical port and the turning prism; and
the third surface is configured to arrange the turning prism, and the fourth surface is configured to arrange the second lens, and wherein the fourth surface is located at a higher level than the third surface.

11. The optical module according to claim 3, wherein
the lower space is recessed towards the upper space to form a first recessed portion and a second recessed portion, wherein the first recessed portion is configured to arrange the laser chip, and a vertical surface of the second recessed portion is configured to arrange the reflector.

12. The optical module according to claim 11, wherein a third lens is arranged in an output optical path of the laser chip, the third lens being configured to collimate the optical emission signal from the laser chip and transmit a collimated optical emission signal to the reflector;
the third lens is arranged in the first recessed portion; and
the first recessed portion is further recessed relative to the second recessed portion.

13. The optical module according to claim 1, wherein there are multiple laser chips, which are divided into a first laser chip array and a second laser chip array, and a thermistor is disposed between the first laser chip array and the second laser chip array;
the reflector comprise a first reflector and a second reflector arranged offset, wherein the first reflector is arranged corresponding to the first laser chip array, and the second reflector is arranged corresponding to the second laser chip array; and
the displacement prism comprises a first displacement prism and a second displacement prism, wherein the first displacement prism is arranged corresponding to the first reflector, and the second displacement prism is arranged corresponding to the second reflector.

14. The optical module according to claim 2, further comprising an interface claw member, wherein one end of the interface claw member is provided with a first claw and a second claw arranged oppositely up and down; an optical fiber plug is arranged between the first claw and the second claw, and one end of the optical fiber plug is disposed with the inner optical fiber;
a first matching portion and a second matching portion are formed on upper and lower sides of the optical fiber port, the first claw is connected with the first matching portion, and the second claw is connected with the second matching portion; and
the optical fiber plug is coupled to the optical fiber port such that the inner optical fiber is passed through the optical fiber port to be coupled with the optical waveguide substrate.

15. The optical module according to claim 14, wherein the cover shell comprises a main body and an extension plate protruded relative to the main body, and wherein the first matching portion is formed on a surface of the main body, and the optical fiber port and the second matching portion are formed on a surface of the extension plate.

16. The optical module according to claim 15, wherein one end of the base is formed with a support groove, and the extension plate is embedded in the support groove; a surface of the support groove is recessed downwards to form a third matching portion, and the third matching portion is arranged opposite to the second matching portion.

17. The optical module according to claim 16, wherein
a width of the extension plate is smaller than a width of the main body so as to form connecting portions between the extension plate and the main body;
a width of the support groove is smaller than a width of the surface of the base so as to form support portions between the support groove and the base; and
the connecting portions are connected to the support portions to connect the cover shell with the base.

18. The optical module according to claim 4, wherein a length of the cover shell is smaller than that of a surface of the upper space, and the optical reception chip and the turning prism are exposed relative to the cover shell.

19. The optical module according to claim 18, wherein a protective cover is covered above the surface of the optical reception chip, wherein one side of the protective cover is connected with a side wall of the cover shell, and another side of the protective cover is connected with the base, and a bottom surface of the protective cover is arranged on the surface of the circuit board.

20. The optical module according to claim 19, wherein the protective cover is formed, on surfaces thereof, with a first notch and a second notch, wherein the first notch is configured to be engaged with the base; the second notch is configured to avoid or make way for the fourth side wall; the first notch is abutted on and connected to the surface of the base; there is a gap between a side wall of the protective cover and the third side wall; and the second notch is matched with and connected to the fourth side wall.
